(19) United States
(12) Patent Application Publication
(10) Pub. No.: US 2026/0289173 A1
(43) Pub. Date: Sep. 24, 2026

(54) SYSTEM

(71) Applicant: SoftBank Group Corp., Tokyo (JP)

(72) Inventor: Masaki FUKE, Tokyo (JP)

(73) Assignee: SoftBank Group Corp., Tokyo (JP)

(21) Appl. No.: 19/564,337

(22) Filed: Mar. 12, 2026

(30) Foreign Application Priority Data
Mar. 19, 2025 (JP) 2025-045063

(51) Int. Cl. G06F 40/40; G06V 10/82; G06V 40/10; G10L 25/30; G10L 25/63

(52) U.S. Cl. CPC G06F 40/40; G06V 10/82; G06V 40/10; G10L 25/30; G10L 25/63

(57) ABSTRACT

A system includes a processor that is configured to receive information input from a user, generate a prompt for instructing a generative AI model to generate a response candidate based on the information input, and input the prompt into the generative AI model to cause the generative AI model to generate the response candidate.

### CROSS-REFERENCE TO RELATED APPLICATION

This application is based on and claims priority under 35 USC 119 from Japanese Patent Application No. 2025-045063 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems that utilize generative AI models typically require users to manually craft prompts or queries in order to obtain appropriate responses. As a result, users who are not familiar with prompt engineering or the internal behavior of generative AI models may receive responses that are irrelevant, incomplete, or inconsistent with their actual intent. Furthermore, conventional systems generally do not effectively utilize past user information when handling inputs that include specific identifiers, and therefore fail to provide optimized data proposals tailored to individual users or historical contexts. In addition, even when useful data is proposed, conventional systems often require users to switch to separate applications or interfaces to perform subsequent procedures, such as reservations, purchases, or other transactions, which reduces convenience and increases the operational burden on the user. Accordingly, there is a need for a system that can automatically generate appropriate prompts for a generative AI model based on user input and past information, that can extract and propose optimal data in response to specific identifiers, and that can allow the user to immediately perform procedures based on the proposed data via an integrated user interface.

### SUMMARY

In order to solve the foregoing problems, the present invention provides a system comprising a processor, wherein the processor is configured to receive information input from a user and to generate, based on the received information input, a prompt for instructing a generative AI model to generate a response candidate. The processor is further configured to input the prompt into the generative AI model so as to cause the generative AI model to generate the response candidate. In one aspect, the processor is configured, when the information includes a specific identifier, to generate a prompt for proposing optimal data by inferring from past information associated with the user or the identifier, and to use the generative AI model to extract related data based on the prompt, thereby enabling provision of data that is optimized to the user's past preferences and context. In another aspect, the processor is configured to present, via a user interface, procedure options that allow the user to perform a procedure based on the proposed data, and to execute the procedure in accordance with a selection by the user, thereby enabling the user to complete reservations, purchases, or other transactions seamlessly within a single integrated system.

The term “system” refers to an arrangement comprising at least one processor and, optionally, one or more memories, interfaces, and external components, configured to execute the functions described in the present specification and claims.

The term “processor” refers to any hardware component or combination of hardware components, such as a central processing unit (CPU), graphics processing unit (GPU), digital signal processor (DSP), application-specific integrated circuit (ASIC), field-programmable gate array (FPGA), or other processing circuitry, that executes instructions to perform the operations described in the present specification and claims.

The term “user” refers to any human operator or entity that provides information input to the system and receives responses, proposed data, or procedure options from the system.

The term “information input” refers to any data or content provided by the user to the system, including but not limited to natural language text, structured data, commands, or identifiers, that serves as a basis for generating prompts or response candidates.

The term “prompt” refers to data generated by the processor, including but not limited to natural language text or structured instructions, that is supplied to a generative AI model in order to instruct the generative AI model to generate a response candidate or to extract related data.

The term “generative AI model” refers to any machine learning model, such as a large language model, image generation model, or other generative model, that is configured to generate responses, content, or data based on input prompts.

The term “response candidate” refers to a response, suggestion, proposal, or other output generated by the generative AI model in accordance with a prompt, and intended to be presented to the user or used for subsequent processing by the system.

The term “specific identifier” refers to any identifier, keyword, token, or other element included in the information input that indicates a particular context, category, user, entity, or request type, and that triggers the processor to perform inference based on past information.

The term “past information” refers to information previously stored or recorded by the system, including but not limited to historical user inputs, usage logs, transaction records, or context data, which can be used by the processor to infer user preferences or other contextual attributes.

The term “optimal data” refers to data selected or generated by the system as being most suitable or relevant for the user or the current context, based on inference from past information and processing by the generative AI model.

The term “related data” refers to data that is extracted or identified by the generative AI model or the processor as having a relationship to the information input, the specific identifier, or the inferred preferences, and that is suitable for presentation or further use in the system.

The term “user interface” refers to any hardware and software combination that enables interaction between the user and the system, including but not limited to graphical user interfaces, web interfaces, mobile application interfaces, voice interfaces, or other input/output mechanisms.

The term “procedure options” refers to selectable items, actions, or workflows presented to the user via the user interface, which, when selected, cause the system to perform a procedure such as a reservation, purchase, registration, or other transaction.

The term “procedure” refers to any processing sequence executed by the system in response to a selection by the user, including but not limited to operations for reservations, purchases, bookings, registrations, or other business or transactional processes.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

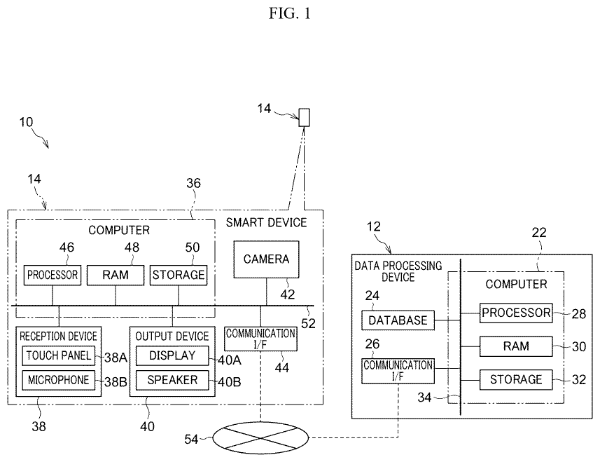

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

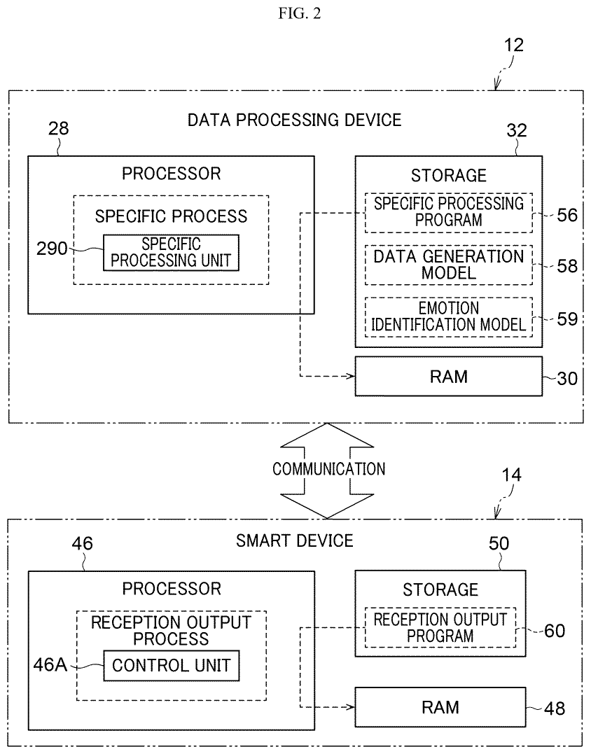

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented dialogue systems that use generative AI models generally treat a user's natural language input as an isolated text string and pass it directly to a model endpoint. In many implementations, a fixed prompt template is simply concatenated with the raw user input and transmitted to a generative model service. As a result, the system does not fully exploit contextual attributes of the input, such as identifiers, user state, or prior interaction history, and therefore cannot efficiently generate responses that are both contextually adapted and immediately actionable for the user.

Moreover, existing architectures typically separate natural language generation from downstream business processing. A generative AI model may produce a natural language answer, but the computing system often leaves it to the user or an external application to interpret the answer, query relevant data sources, and initiate transactions. This leads to additional client-side logic, repeated network calls, and fragmented flows, which increases latency, resource consumption, and the likelihood of inconsistent behavior across different terminals.

From a computer technology perspective, these conventional approaches fail to provide an integrated mechanism by which a server-side processor dynamically restructures user input into structured data, derives an adaptive prompt sentence that encodes retrieval and reasoning instructions for a generative AI model, and converts the model's candidate response and retrieved data into machine-usable control information. In particular, known systems do not efficiently utilize specific identifiers embedded in user input to drive automated search operations over stored data and to synthesize, in a unified server-side process, both natural language responses and executable options for immediate user actions.

Consequently, there is a need for an improved computer-implemented system and server-side processing architecture that: (i) systematically converts user input into structured data suitable for machine processing and communication; (ii) dynamically generates prompt sentences to a generative AI model based on the content and attributes of the input, including specific identifiers; (iii) uses the generative AI model not merely for free-form language generation but as a component in a controlled pipeline that extracts related data from past information; and (iv) produces, in a single integrated flow, both human-readable response data and control information that can directly trigger transaction or registration processing. Such an arrangement would improve the efficiency, consistency, and responsiveness of the underlying computer system itself, rather than simply automating human tasks with an otherwise unchanged architecture.

The specific processing by the specific processing unit 290 of the data processing device 12 in Example 1 is realized by the following means.

The present invention provides a server comprising a processor configured to receive information input from a user via a terminal, convert the information input into structured data, and transmit or receive the structured data via a communication network; to dynamically generate, on a basis of content and attributes included in the information input, a prompt sentence that instructs a generative AI model to generate a candidate response, input the prompt sentence into the generative AI model, and acquire the candidate response generated by the generative AI model through natural language processing; to detect, when the information input includes a specific identifier, the specific identifier from the information input, execute a search process on past information stored in a storage device on a basis of the specific identifier, and generate the prompt sentence including conditions and constraints for proposing optimal data so that the generative AI model extracts related data from the past information; and to generate response data, on a basis of the candidate response and the related data, including display data for presentation to the user and operation information defining procedure items selectable on a user interface of the terminal, and to generate control information to execute predetermined transaction processing or registration processing on a basis of selection information received from the terminal. This enables an integrated server-side computation flow in which user input is normalized into machine-processable structured data, an adaptive prompt sentence is constructed to guide the generative AI model in both response generation and data extraction, and the resulting candidate response and related data are transformed into both human-readable output and machine-readable control information, thereby improving the efficiency, responsiveness, and functional coupling of natural language processing and transaction execution in the underlying computer system.

The term “processor” refers to a hardware information processing unit, such as a central processing unit or an execution core, that executes program instructions to perform data processing, control, and communication operations.

The term “terminal” refers to an information processing apparatus used by a user, including at least one input unit, display unit, and communication unit, and configured to send information input by the user to a server and to present response data received from the server.

The term “user” refers to a human operator who interacts with the system through the terminal by providing information input and by viewing or selecting response data or procedure items presented by the terminal.

The term “information input” refers to data that is provided by the user through an input interface of the terminal, including at least a natural language expression such as a question, request, or instruction.

The term “structured data” refers to information that has been converted from the information input into a machine-processable format with a defined structure, such as a key-value representation, a record, or a message body suitable for transmission over a communication network.

The term “communication network” refers to an interconnected communication infrastructure, including at least one wired or wireless network, configured to transmit and receive data between the terminal and the server.

The term “prompt sentence” refers to a text sequence, including at least one instruction and optionally conditions or constraints, that is generated on the basis of the information input and is supplied to a generative AI model in order to cause the generative AI model to generate a candidate response or to perform data extraction.

The term “generative AI model” refers to a machine learning model that processes text or related data and generates, on the basis of a prompt sentence and learned parameters, new text such as a candidate response, using natural language processing techniques.

The term “candidate response” refers to a text output generated by the generative AI model in response to the prompt sentence, and representing at least a provisional answer, explanation, or suggestion to the information input.

The term “display data” refers to data defining content to be visually or otherwise perceptibly presented to the user on the terminal, including at least the candidate response and optionally associated information such as labels, buttons, or links.

The term “response data” refers to a data set generated by the processor on the basis of the candidate response and optionally other data, and including at least display data and, in some cases, operation information specifying procedure items or processing options.

The term “processing options” refers to a set of selectable operations presented to the user, each operation being associated with a procedure or processing that can be executed by the system, such as a transaction processing or a registration processing.

The term “specific identifier” refers to a data element, such as a symbol, code, or string, included in the information input, and used to uniquely or distinctively identify related records or entities in past information stored in a storage device.

The term “past information” refers to data previously stored in a storage device, including at least historical records, transaction logs, user profiles, or other information associated with one or more specific identifiers.

The term “storage device” refers to a non-transitory computer-readable medium, such as a semiconductor memory or a magnetic or optical storage apparatus, configured to store past information, program instructions, and data used by the processor.

The term “related data” refers to data that is retrieved or derived from the past information on the basis of the specific identifier and optionally further conditions, and that is relevant to the information input or to the candidate response.

The term “optimal data” refers to a subset of related data that satisfies one or more conditions or constraints defined in the prompt sentence or in server-side logic, and that is considered most suitable for presentation or use in a particular context.

The term “operation information” refers to data defining one or more procedure items or selectable options to be presented on the user interface of the terminal, each item being associated with a corresponding processing or control action to be executed when selected by the user.

The term “procedure items” refers to individual selectable entries within the operation information that represent specific actions, such as confirming a reservation, executing a purchase, registering information, or navigating to a detailed screen.

The term “user interface” refers to a software-controlled presentation and input environment provided by the terminal, including at least display components and input components that enable the user to view display data and to input information, selections, or commands.

The term “transaction processing” refers to a computer-implemented operation that modifies or creates persistent data related to a commercial, service, or resource-management event, such as booking, purchasing, or updating a record, typically with integrity and consistency guarantees.

The term “registration processing” refers to a computer-implemented operation that stores or updates registration information in the storage device, such as user information, preferences, or enrollment data, in association with one or more identifiers.

The term “control information” refers to data generated by the processor on the basis of a selection of procedure items, and defining how the system is to execute predetermined processing, including at least transaction processing or registration processing.

The term “content and attributes included in the information input” refers to the semantic content, syntactic structure, metadata, and other characteristics of the information input, including the presence of specific identifiers, language type, category, or context.

In one embodiment, a server cooperates with a terminal operated by a user to implement the claimed system. The server includes at least one processor, a main memory, a non-transitory storage device, and a communication interface connected to a communication network. The terminal includes at least one processor, a memory, a display unit, an input unit such as a touch panel or keyboard, and a communication unit. The user operates the terminal to input information and to view responses and selectable procedure items.

The server executes software components including at least: a network interface module, a request parsing module, a prompt generation module, a model interface module for a generative AI model, a data access module, a response generation module, and a transaction control module. The terminal executes software components including at least: a user interface module, an input acquisition module, a communication client module, and a display control module.

The terminal presents, on the display unit, a user interface screen implemented by an application such as a native mobile application, a desktop application, or a web application executed in a general-purpose web browser. The user inputs information in natural language, such as questions, requests, or commands, through a text input area or equivalent graphical control. The terminal converts the input into an internal data structure, such as an object or record, stored in the memory, and associates one or more attributes such as a user identifier, a timestamp, a language code, or a category label determined from the current application state.

The terminal uses the communication client module to construct structured data, for example a set of key-value fields, including at least an input text field and an attribute field. The terminal applies a serialization routine using a standard data format so that the structured data is suitable for transmission via the communication network. The terminal sends the resulting structured data to the server via the communication interface. The use of structured data, rather than raw text only, allows the server to efficiently parse the data, infer context, and apply optimized routing and caching strategies, thereby reducing processing overhead and network round-trips compared with conventional systems that treat the user input as an unstructured text blob.

The server receives the structured data by the network interface module and stores the received data into a request buffer region in the main memory. The server uses the request parsing module to decode the structured data and to extract at least the natural language input and associated attributes. The server identifies whether the information input includes one or more specific identifiers by applying pattern recognition procedures such as regular expression matching or token-level classification. For example, the server can detect alphanumeric patterns that match a predefined identifier schema and can tag these tokens as identifiers in an intermediate representation.

The server converts the information input and the extracted attributes into an internal representation suitable for prompt generation. In one embodiment, the server represents the input text as a sequence of tokens, each token being associated with metadata indicating its type (for example, plain text, identifier, numerical value, date, or category). The server stores this sequence and metadata in a structured data structure, such as a list of token entries in the main memory. This arrangement allows the server to systematically process the input at the token level and to insert, omit, or reorder certain elements when constructing a prompt sentence.

The server uses the prompt generation module to dynamically generate a prompt sentence for a generative AI model. The server retrieves one or more template segments from the storage device, where each template segment corresponds to a predefined instruction block. The server selects appropriate template segments based on at least one of: the detected presence of identifiers, the type of user request, or the user's historical interaction pattern obtained from past information. The server then combines the template segments with the user input, optionally tagging the input or identifiers with explicit labels or delimiters that inform the generative AI model how to treat each component.

For example, the server can generate a prompt sentence such as:

“You are an assistant that answers user questions clearly and concisely in English. Generate an appropriate reply to the following user question. Question: Tell me today's news.”

As another example, when identifiers and past information are involved, the server can generate a prompt sentence such as:

“You are an AI assistant that uses the following user profile and history to provide a personalized answer and a single recommended option. User input: I want to know today's economic news and what seminar I should attend. User history: [summary of past seminars and interests]. Produce a short explanation and one concrete seminar recommendation.”

The server can also generate a constrained prompt sentence such as:

“You are a concise news assistant. Answer the following question in no more than three sentences and focus only on the most important topics. Question: Tell me today's news.”

In these examples, the server does not merely attach the user input to a fixed header; instead, the server conditions the prompt sentence on dynamically determined factors, including the presence or absence of specific identifiers and the outcome of search operations on past information. This dynamic prompt construction causes the generative AI model to focus its internal computation on relevant information and tasks, thereby reducing unnecessary token generation and improving response precision and consistency.

The server uses the model interface module to interact with a generative AI model. In one embodiment, the server hosts a generative AI model locally using a machine learning framework such as a tensor computation library. The generative AI model can be implemented as a transformer-based neural network, comprising an embedding layer, multiple self-attention layers, feed-forward layers, and a final output projection layer. The server stores model parameters, including weight matrices and bias vectors, in the storage device and loads them into main memory and, where available, into a graphics processing unit memory.

The server tokenizes the prompt sentence into discrete tokens using a subword tokenizer, such as a byte pair encoding tokenizer. Each token is converted into an embedding vector by the embedding layer. The server then executes, on the processor or on a graphics processing unit, a sequence of matrix multiplications and non-linear activation operations as defined by the transformer architecture. Self-attention mechanisms compute attention scores between tokens by applying learned projection matrices to the token embeddings, performing dot products, and normalizing the results via a softmax function. The server iteratively generates output token probabilities at each position according to the model's parameters and sampling or decoding policy.

In another embodiment, the server accesses a generative AI model provided by an external service via an application programming interface. In this case, the server sends the prompt sentence and model parameters such as maximum token length, temperature, and top-p threshold to the external model endpoint via a secure communication channel. The server receives, from the external model, a sequence of tokens representing the candidate response. The server then decodes the tokens into a text string, which is stored in the main memory and passed to the response generation module.

During model inference, the server applies several technical strategies to improve computational efficiency and response quality. For instance, the server shortens the prompt sentence by summarizing user history into a compact representation using a separate summarization model or heuristic rule set, reducing token length and inference time. The server also adjusts decoding parameters, such as lowering the temperature value when a specific identifier is present and past information has been retrieved, thereby biasing the model towards more deterministic outputs that better match stored data. This combination of prompt conditioning and parameter control reduces unnecessary variability and improves the reproducibility of candidate responses.

The server uses the data access module to retrieve past information associated with specific identifiers. When the information input includes a specific identifier, the server extracts the identifier and issues a query to a storage device, such as a relational database management system or a document store. The server can normalize the identifier according to a predefined schema and use indexed lookup operations to retrieve related records. The retrieved data is stored in an internal data structure in the main memory and can be summarized or filtered to form “related data” that is relevant to the current information input.

The server may generate an additional prompt segment that explicitly encodes the related data for the generative AI model. For example, the server can produce:

“User history summary: Attended three previous seminars on macroeconomics and financial policy. Preferred topics: economic growth, inflation.”

The server can append this segment to the prompt sentence or can treat it as a separate input field, depending on the model interface. By including a structured summary of related data as part of the prompt sentence, the server allows the model to condition its output on concrete historical information, rather than relying solely on abstract statistical patterns. This results in improved personalization and more accurate alignment with the user's prior context.

Alternatively, the server can use the generative AI model itself for data extraction by constructing a prompt sentence that instructs the model to select or rank relevant entries from a list of candidate records derived from the past information. In such a case, the server supplies a list of candidate items, each represented by a concise textual description, and instructs the model to choose the single most relevant item according to specified criteria. The server then parses the model's output to identify the selected item and treats this as the optimal data to be proposed. This approach uses the model's pattern recognition capability to perform a ranking function that may be difficult to encode using conventional deterministic rules alone.

The server uses the response generation module to convert the candidate response and the related data into response data suitable for presentation on the terminal. The server constructs display data that includes the candidate response as text and may include additional explanatory content or highlights. In parallel, the server generates operation information defining procedure items that the user can select. Each procedure item is associated with a specific type of transaction processing or registration processing to be executed by the transaction control module when selected.

For example, the server can generate response data such as:

“Today's main news is the rise in the economic growth rate, supported by strong consumer spending and increased exports. Based on your past seminar history, the most suitable seminar for you is ‘Economic Outlook Seminar’ on March 15. You can choose to reserve a seat for this seminar now.”

In conjunction with this text, the server can define procedure items such as “Reserve a seat” and “View seminar details,” each linked to internal identifiers in the server's database. The server encodes these procedure items and associated control parameters as part of the response data, which is then transmitted to the terminal.

The terminal receives the response data and uses the display control module to present the candidate response and the procedure items on the user interface. The user can select a procedure item, for example by tapping a button or clicking a link on the screen. The terminal collects the user's selection, converts it into structured data that includes the identifier of the selected procedure item and the relevant context, and transmits this data to the server via the communication network.

The server receives the selection data and uses the transaction control module to interpret the selected procedure item. The server generates control information that specifies which transaction processing or registration processing to execute and which parameters and records are involved. The server then performs the corresponding operations on the storage device, such as creating or updating a record representing a reservation, a purchase, or a registration. By encoding the selection as machine-readable control information, the system reduces ambiguity and decreases the likelihood of errors or misinterpretations that can occur when natural language responses are manually translated into actions.

The above architecture provides technical effects that go beyond mere automation of human tasks. By transforming user input into structured data and dynamically generating prompt sentences that explicitly encode system-level constraints and data retrieval instructions, the server improves the way computing resources are used. The dynamic prompt generation reduces the length and redundancy of data supplied to the generative AI model, which in turn reduces the number of mathematical operations required during inference and lowers latency. The combination of identifier detection, indexed retrieval from storage, and model-guided selection supports more accurate and contextually appropriate outputs, thereby reducing the need for repeated queries and retries.

Additionally, by generating response data that is not only human-readable but also linked to specific procedure items and control information, the server tightly couples natural language processing with deterministic transaction logic in a way that is not achievable by manual human workflows. The server effectively converts a sequence of opaque language interactions into a structured control flow at the machine level. This improves data management, consistency of state between the terminal and the server, and overall computing efficiency, because the system avoids redundant data parsing and ad hoc client-side scripting that are common in conventional architectures.

The generative AI model itself is trained using a supervised or semi-supervised learning procedure. The server or an associated training subsystem supplies training data consisting of pairs of input sequences (prompt sentences plus context data) and output sequences (desired candidate responses or selection labels). During training, the model computes a loss value, such as cross-entropy, between its predicted token distributions and the ground truth tokens. The training process updates the model's weight parameters by applying optimization algorithms such as stochastic gradient descent or variants thereof. The training may include data augmentation procedures, such as paraphrasing, synonym replacement, and noise injection, to improve the model's robustness to variations in user input.

Because the generative AI model learns to interpret prompt sentences that include explicit tags for identifiers and past information, the model develops internal representations that distinguish between different roles of tokens (for example, main question text versus context data). This leads to improved internal attention patterns and better focus on relevant parts of the input during inference. Consequently, the system can generate candidate responses that are more accurate and stable than those produced by models trained solely on unconstrained free-form text inputs.

In a further embodiment, the server uses multiple generative AI models or modules. For example, the server can use a smaller, specialized model for summarization of past information and a larger, more general model for final response generation. The server can also employ a rule-based pre-filtering stage that excludes irrelevant segments of past information before passing a compact summary to the generative AI model. This layered architecture reduces computational cost and improves response time, because the main model operates on fewer tokens and more targeted content.

In another embodiment, the server adjusts the selection of templates and prompt structures depending on network conditions or system load. When the server detects high load or constrained resources, the server can select simpler templates and shorter prompt sentences to reduce inference time. When resources are more abundant, the server can include richer context in the prompt sentence to maximize response quality. Such adaptive prompt management is a non-conventional technique that directly improves the technical performance of the computer system by controlling trade-offs between latency and accuracy in real time.

The system may be implemented on various hardware configurations. The server can be a single physical machine or a cluster of machines, with a load balancer distributing requests. Each server instance can host one or more processors, optional graphics processing units, and storage devices. The terminal can be any computing device, including, but not limited to, a handheld device, a tablet device, or a desktop device. Variations in hardware and software implementation, including different operating systems, database engines, and model frameworks, can be adopted as long as the system performs the functions of structured data generation, dynamic prompt sentence construction, generative AI model interaction, related data extraction, response data generation, and control information generation as described.

Because the server transforms natural language inputs into structured control flows, and because the server dynamically controls model behavior through prompt sentences tailored to both content and identifiers, the system realizes improvements in processing speed, response accuracy, and resource utilization. The combination of these elements constitutes an improvement in computer technology as such, rather than a mere automation of existing human decision-making processes.

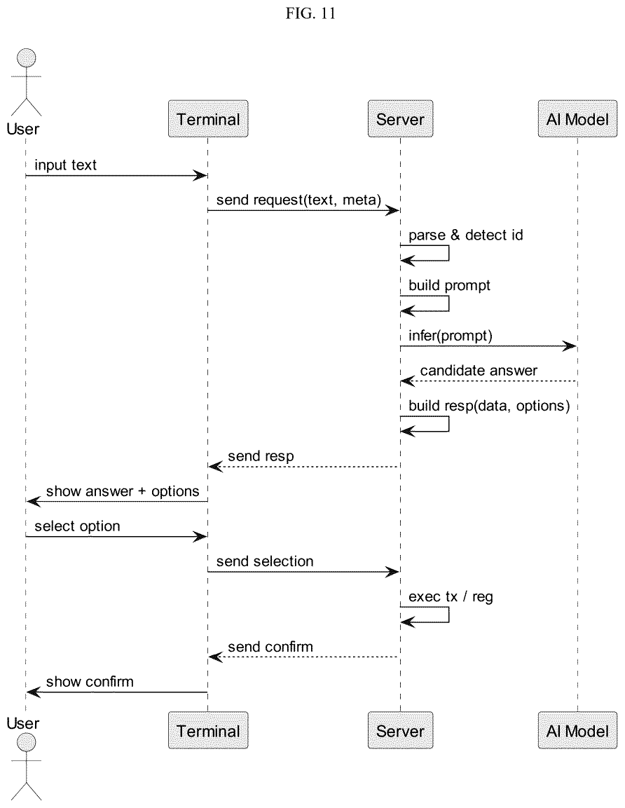

The following describes the processing flow using FIG. 11.
Step 1:

User operates the terminal to start an application and open a screen for input.

User views an input field displayed on the terminal and decides a question or request to be entered.

Input: No digital input; user has an intention or query in natural language.

Output: User is ready to enter text on the terminal.
Step 2:

User inputs information into the terminal via an input interface.

User types a natural language sentence, for example “Tell me today's news.”, into a text box and activates a send operation.

Input: User's keystrokes or touch operations on the input interface.

Output: A text string stored in the terminal's memory as “user_input”.
Step 3:

Terminal converts the user_input into structured data.

Terminal constructs an internal data object with fields such as “text”, “user_id”, “timestamp”, and “language”, and assigns the user_input to the “text” field while generating or looking up the other fields.

Input: The raw text string “user_input” and current application context (user_id, time, language).

Output: A structured record containing key-value pairs representing the input information.
Step 4:

Terminal serializes the structured record into a transmission-ready format and sends it to the server.

Terminal applies a serialization routine to transform the record into a formatted message, and uses a communication module to transmit the message to a specified server address through a communication network.

Input: Structured record in terminal memory.

Output: A transmitted data packet containing the serialized structured data, delivered over the network to the server.
Step 5:

Server receives the transmitted data packet and reconstructs the structured record.

Server uses a network interface to capture the data packet, applies a deserialization routine to parse the formatted message, and stores the reconstructed structured record in main memory.

Input: Serialized data packet from the terminal.

Output: A structured record in server memory containing at least the input text and associated attributes.
Step 6:

Server analyzes the structured record and extracts identifiers and attributes.

Server scans the input text using pattern matching rules to detect specific identifiers, and reads attribute fields such as user_id and language; server then creates an intermediate representation in which tokens and identifiers are tagged.

Input: Structured record with text and metadata.

Output: An intermediate representation including a token sequence, identifier flags, and attribute values.
Step 7:

Server selects a prompt template and generates a prompt sentence for a generative AI model.

Server chooses a template based on the presence of identifiers and the type of request, and then inserts the user text and, when applicable, summary information or constraints to form a complete instruction string; for example, server creates:

“You are an assistant that answers user questions clearly and concisely in English. Generate an appropriate reply to the following user question. Question: Tell me today's news.”

Input: Intermediate representation (token sequence, flags, attributes) and stored template strings.

Output: A prompt sentence string to be supplied to the generative AI model.
Step 8:

Server performs optional retrieval of past information when a specific identifier is present.

Server reads identifier values from the intermediate representation, issues a query to a storage device using indexed lookup, and gathers related records; server may then summarize these records into a compact text description.

Input: Identifier flags and values from the intermediate representation.

Output: A set of related records and, optionally, a textual summary describing relevant past information.
Step 9:

Server augments the prompt sentence with related data when appropriate.

Server concatenates or embeds the summary of past information into the prompt sentence, for example by appending a segment such as “User history summary: [summary text]”, and adjusts instructions to request a recommendation or extraction from the generative AI model.

Input: Base prompt sentence and summary of related data.

Output: An augmented prompt sentence that encodes both the user question and context derived from past information.
Step 10:

Server converts the prompt sentence into tokens and feeds them to the generative AI model.

Server applies a tokenizer to split the prompt sentence into tokens, maps tokens to numerical identifiers, and loads these identifiers into model input buffers for processing by a transformer-based neural network.

Input: Prompt sentence string created by the server.

Output: A sequence of token identifiers passed into the generative AI model as input.
Step 11:

Server executes inference of the generative AI model to generate a candidate response.

Server performs matrix multiplications, attention computations, and non-linear activations over multiple transformer layers using the token identifiers, and iteratively predicts output tokens until termination criteria such as end-of-sequence or maximum length are met.

Input: Sequence of token identifiers representing the prompt sentence.

Output: A sequence of output token identifiers representing a candidate response.
Step 12:

Server decodes the output token identifiers into a text string.

Server applies a decoder mapping from token identifiers to text fragments, concatenates these fragments according to token order, and normalizes spacing and punctuation to form a human-readable sentence or paragraph.

Input: Sequence of output token identifiers from the generative AI model.

Output: A candidate response string in natural language.
Step 13:

Server optionally extracts or confirms specific data from the candidate response.

Server analyzes the candidate response text using parsing or pattern recognition to detect references to records, dates, or options, and matches these references with related records retrieved earlier to ensure consistency and completeness.

Input: Candidate response string and previously obtained related records.

Output: A verified candidate response and a set of bound data items linked to the response.
Step 14:

Server generates response data including display data and operation information.

Server constructs a response structure that contains the candidate response as text and a list of procedure items, each procedure item carrying an internal identifier and parameters that define a specific transaction or registration operation.

Input: Verified candidate response and bound data items.

Output: A response data structure comprising display data and machine-actionable operation information.
Step 15:

Server serializes the response data and sends it to the terminal.

Server transforms the response structure into a formatted message, encapsulates it in a network packet, and transmits the packet through the communication network to the terminal's address.

Input: Response data structure created by the server.

Output: A transmitted response packet carrying the serialized response data.
Step 16:

Terminal receives and reconstructs the response data.

Terminal uses its communication module to obtain the response packet, deserializes the formatted message, and rebuilds a local representation of the response data structure in memory.

Input: Serialized response packet from the server.

Output: A local response data structure containing candidate response text and procedure item definitions.
Step 17:

Terminal updates the user interface to display the candidate response and selectable procedure items.

Terminal renders the candidate response text in a display component and generates interactive controls, such as buttons or list entries, corresponding to the procedure items, and associates each control with its internal identifier.

Input: Local response data structure with display data and operation information.

Output: A displayed user interface state showing the response text and user-selectable options.
Step 18:

User reviews the displayed information and selects one of the procedure items.

User taps or clicks an interactive control corresponding to a desired action, such as “Reserve a seat” or “View details”, thereby instructing the terminal to proceed.

Input: Visual presentation of the candidate response and procedure items.

Output: A user selection event linked to a specific procedure item.
Step 19:

Terminal converts the user selection event into structured selection data and transmits it to the server.

Terminal identifies the procedure item identifier associated with the selected control, combines it with current context information such as user_id and session data, and serializes this selection data for transmission over the network.

Input: User selection event and local mapping from controls to procedure item identifiers.

Output: A serialized selection message sent to the server.
Step 20:

Server interprets the selection data and generates control information for backend processing.

Server parses the selection message, determines the type of operation to perform based on the procedure item identifier, and composes control parameters such as resource identifiers, quantities, or dates; server encapsulates these parameters as control information for transaction or registration logic.

Input: Structured selection data from the terminal.

Output: Control information specifying a concrete transaction processing or registration processing to execute.
Step 21:

Server executes the specified transaction processing or registration processing using the control information.

Server accesses the storage device to create or update records representing the requested operation, for example inserting a reservation record or updating a user profile, and applies consistency checks or constraints defined by the system's rules.

Input: Control information including operation type and parameters.

Output: Updated persistent data in the storage device and a processing result status.
Step 22:

Server generates a confirmation response based on the processing result status.

Server creates a confirmation message that indicates success or failure of the requested operation and may include details such as a reservation number or updated information, and packages this into a response data structure.

Input: Processing result status and any new or updated records.

Output: A confirmation response data structure ready to be sent to the terminal.
Step 23:

Server sends the confirmation response to the terminal, and terminal displays the confirmation to the user.

Server serializes and transmits the confirmation response, and terminal deserializes it and updates the user interface to present a confirmation message, such as “Your reservation has been completed.”, allowing the user to verify that the requested operation has been carried out.

Input: Confirmation response data structure at the server side.

Output: A visible confirmation message on the terminal and a final consistent state between server records and user perception.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content delivery systems and recommendation engines typically rely on manually designed rules or simple statistical models that operate on pre-existing content items. Such systems often treat user input as a static query and do not exploit rich contextual information, such as a user's accumulated usage history, evolving preferences, or real-time interaction patterns, in a unified and dynamic manner. As a result, these systems frequently provide content that is only loosely aligned with a user's true intent and do not adapt efficiently to changes in user behavior.

Furthermore, in many existing architectures, a generative AI model, if used at all, is invoked in a coarse-grained fashion with generic prompts that are not systematically constructed from structured usage data. The prompt construction is often ad hoc and does not reflect inferred preference indicators or past interaction outcomes. This leads to suboptimal utilization of the generative AI model's capabilities, increased trial-and-error interactions by the user, and inefficient consumption of computing resources in the server and communication resources between the server and the terminal.

In addition, existing systems provide limited support for iterative, real-time refinement of generated content. When a user wishes to adjust style, length, or thematic focus of generated content, the user is typically required to manually reformulate the entire request. The server-side processing does not automatically redesign prompt sentences based on user operations, nor does it systematically incorporate previous generation results into a new round of generation. Consequently, the user experience is fragmented, and the underlying computer system fails to optimize processing flows and data transformations for iterative natural language generation. There is also a technical challenge in efficiently linking recommendation logic with generative logic. In many systems, recommendation of themes or content types is separated from content generation, and recommendations are produced solely by conventional database queries or collaborative filtering algorithms. These approaches do not leverage the generative AI model itself to synthesize explanatory recommendation information tailored to user context. As a result, the system does not fully exploit generative models to produce structured, human-readable recommendation content, which limits both relevance and interpretability for the user. Accordingly, there is a need for an improved computer-implemented system and method that (i) systematically acquires user input and past usage data, (ii) infers user preference indicators in a machine-processable form, (iii) constructs and updates prompt sentences for a generative AI model in a structured and automatic manner, and (iv) supports iterative refinement and recommendation flows. Such a system should improve the way processors, memory, and communication interfaces are orchestrated to generate, refine, and deliver customized content, thereby enhancing the efficiency, adaptability, and technical performance of content generation and recommendation on computer networks.

The specific processing by the specific processing unit 290 of the data processing device 12 in Application Example 1 is realized by the following means.

The present invention provides a server comprising a processor and a memory storing instructions which, when executed by the processor, cause the processor to acquire information input including a content of interest of a user from a terminal, convert the information input into structured data, obtain past usage history information associated with the user from a storage device, estimate at least one preference indicator of the user based on the content of interest and the past usage history information, generate a prompt sentence based on the content of interest and the at least one preference indicator for instructing a generative AI model to execute a generation process, input the prompt sentence to the generative AI model, obtain a generation result as a content candidate from the generative AI model, perform post-processing including at least one of formatting, length adjustment, and safety checking of the content candidate to create response data interpretable by the terminal, transmit the response data to the terminal for presentation to the user, receive from the terminal a user operation including at least one of a regeneration instruction, a style change instruction, and a new theme proposal request with respect to the presented content candidate, and, in response to the user operation, update the prompt sentence and repeatedly execute an additional content generation process by the generative AI model using the updated prompt sentence. This enables the computer system to automatically transform raw user input and accumulated usage history into dynamically optimized prompt sentences for a generative AI model, to iteratively refine generated content in real time based on user interactions, and to improve the technical efficiency and adaptability of content generation and recommendation processing across the server and terminal.

The term “system” refers to an arrangement of one or more computing devices, including at least a server-side information processing apparatus and one or more terminals, that cooperate via one or more communication networks to execute the processes described in the claims.

The term “processor” refers to an execution unit, such as a central processing unit, a microcontroller, or a processing core of a system-on-chip, that executes instructions to perform arithmetic, logical, and control operations associated with the claimed processes.

The term “memory” refers to one or more storage media, such as semiconductor memory, magnetic storage, or optical storage, that store instructions and data for access by the processor.

The term “terminal” refers to a user-operated computing device, such as a mobile device, a tablet device, a desktop device, or a browser-executing device, which communicates with the information processing apparatus and presents content to the user.

The term “information processing apparatus” refers to a computing device or a group of computing devices, including server hardware and associated software, that receive, store, process, and transmit data in connection with the functions of the system.

The term “communication path” refers to a logical or physical communication link, including wired or wireless communication networks, over which data is transmitted between the terminal and the information processing apparatus.

The term “information input” refers to data representing a user's request, including at least a content of interest or a theme and optionally additional parameters, that is received from the terminal.

The term “content of interest” refers to a subject, topic, theme, or preference specified by the user, which is used as a basis for generating or recommending content.

The term “structured data” refers to data that has been converted from raw user input into a machine-readable and organized format, such as a record or a data object including predefined fields.

The term “user identification information” refers to data that uniquely or pseudo-uniquely associates input or usage history with a particular user, such as a user identifier, account identifier, or session identifier.

The term “past usage history information” refers to stored data describing previous interactions of the user with the system, including past requests, selected themes, generated content, feedback, and interaction results.

The term “preference indicator” refers to a parameter or set of parameters inferred from the content of interest and the past usage history information that quantitatively or qualitatively represent the user's preferences, tendencies, or behavioral patterns.

The term “generative AI model” refers to a software-implemented information processing model, such as a neural network-based language model, that generates new data, including text content, in response to input data such as a prompt sentence.

The term “prompt sentence” refers to a textual instruction or request, constructed in natural language or machine-interpretable form, that is provided to the generative AI model to control or guide the content generation process.

The term “generation process” refers to a sequence of operations executed by the generative AI model to produce a content candidate in response to a prompt sentence, including tokenization, probabilistic inference, and text output.

The term “content candidate” refers to content generated by the generative AI model based on a prompt sentence, such as a story, an article, a list of recommendations, or other natural language output, prior to final post-processing.

The term “post-processing” refers to processing performed on a content candidate after generation by the generative AI model, including at least one of formatting, length adjustment, and content safety checking.

The term “response data” refers to data derived from the content candidate after post-processing, formatted in a structure interpretable by the terminal and suitable for presentation to the user.

The term “user display area” refers to a portion of a graphical user interface of the terminal that is configured to present generated content, recommendations, or options for interaction to the user.

The term “user operation” refers to an input action performed by the user via the terminal, including but not limited to selection, button activation, or command input, that indicates a request for regeneration, style change, new theme proposals, or other modifications.

The term “regeneration instruction” refers to a user operation that requests the system to generate new or alternative content based on a same or related content of interest.

The term “style change instruction” refers to a user operation that requests the system to modify stylistic aspects of the generated content, such as tone, formality, length, or level of detail.

The term “new theme proposal request” refers to a user operation that requests the system to propose one or more new themes or content types suitable for subsequent content generation.

The term “specific identification information” refers to an identifier or marker included in the information input or the user operation that indicates a particular processing mode, request type, or classification, such as a recommendation request or a special handling flag.

The term “request type” refers to a classification of a request, indicating a type of processing to be performed, such as content generation, content refinement, or theme recommendation.

The term “usage tendency information” refers to aggregate or generalized data describing behavior patterns of multiple users, such as frequently selected themes, typical interaction sequences, or popularity statistics.

The term “candidate theme” refers to a potential subject or topic proposed for future content generation, selected or generated based on past usage history information and usage tendency information.

The term “candidate content type” refers to a category or format of content, such as narrative content, explanatory content, list-based content, or procedural content, proposed as an option for the user.

The term “recommendation information” refers to natural language or structured descriptions that explain or present one or more candidate themes or candidate content types to the user as suggestions.

The term “user interface” refers to a hardware and software environment on the terminal, including visual, auditory, and input components, through which the user views content and performs user operations.

The term “option group” refers to a set of selectable items or representations, such as summaries, structured item displays, or lists of candidates, presented to the user for selection via the user interface.

The term “summary” refers to a condensed representation of content that captures key elements or an outline of the content in reduced length.

The term “structured item display” refers to a form of presentation that divides content into discrete labeled elements, sections, or fields, making it easier for the user to understand and select specific parts.

The term “list display” refers to a visual arrangement in which multiple candidates or options are presented in a list format, each optionally including a title, brief description, or metadata.

The term “selection result” refers to data indicating which option or options in an option group have been chosen by the user, as detected by the user interface.

The term “procedure processing data” refers to data generated using the generative AI model that is structured for use in executing or assisting a task, operation, or workflow, such as step-by-step instructions, forms, or parameter sets.

The term “detailed content” refers to content generated by the generative AI model that includes extended explanations, elaborated narratives, or in-depth information beyond an initial brief output.

In one embodiment, a server, a terminal, and a user cooperate to implement the invention.

The server includes at least one processor, a main memory, a non-volatile storage device, a network interface, and an operating system such as a general-purpose server operating system.

The server executes application programs implemented, for example, using an application framework on a runtime environment such as a virtual machine or an interpreter. The server also accesses a storage subsystem such as a relational database system. The server communicates with an external generative AI model executed on an external computing infrastructure that provides specialized processing hardware such as graphics processing units or tensor processing units.

The terminal includes a processor, a memory, a display device such as a liquid crystal display or an organic light emitting diode display, an input device such as a touch panel, a network interface such as a wireless communication module, and an operating system such as a mobile operating system or a desktop operating system. The terminal executes an application program or a browser-based client program that implements a user interface for inputting information and for displaying generated content and recommendation information.

The user operates the terminal to input information that includes at least a content of interest. The user can input such information by typing text into an input field, selecting one or more themes from a list, or interacting with graphical elements such as buttons and sliders. The terminal converts the input into a structured representation, such as a record with fields for user identification, theme, language, content type, and refinement parameters. The terminal then sends this structured representation to the server via a communication network using a protocol such as hypertext transfer protocol secure over transmission control protocol and internet protocol.

The server receives the structured data and stores it temporarily in memory. The server then accesses a storage device in which past usage history information is stored. The server retrieves records associated with the user identification contained in the structured data. Each record may include a theme string, interaction metadata such as a timestamp, a rating, a click event, or a completion flag, and content attributes such as genre tags, style attributes, or length. The server loads these records into an in-memory data structure such as an array or a table, and computes preference indicators by applying algorithms such as frequency counting, weighted averaging, and tag-based clustering.

In one embodiment, the server represents preference indicators as a vector of numerical scores, where each dimension corresponds to a feature such as a genre (for example, fantasy, science fiction, mystery), a style (for example, humorous, serious, concise), or a structural attribute (for example, short length, long length). The server normalizes counts and ratings into a bounded range, and uses a function such as a weighted sum or cosine similarity to highlight frequently selected or highly rated features. The server thus computes a preference indicator vector that reflects the user's tendencies in a machine-processable form.

The server then generates a prompt sentence for a generative AI model. The server uses the content of interest and the preference indicator vector to populate a prompt template. The server can maintain multiple prompt templates for different content types, such as narrative content, explanatory content, or recommendation content. For example, when the user selects a fantasy adventure theme, and the preference indicator indicates a preference for strong female protagonists and detailed world-building, the server may generate a prompt sentence such as:

“Please generate a fantasy adventure story set in a medieval magical kingdom based on the theme ‘fantasy adventure’. The user prefers strong female protagonists and detailed world-building. Please keep the story under 1500 words and use an engaging, cinematic style suitable for young adults.”

In another example, when the user requests vegetarian breakfast recipes, the server may generate a prompt sentence such as:

“You are a professional nutritionist and chef. Please generate an article that introduces 5 healthy vegetarian breakfast recipes suitable for busy office workers. For each recipe, list the ingredients, step-by-step preparation instructions, and approximate cooking time. Use clear and concise English that a beginner can follow.”

The server constructs these prompt sentences using a deterministic algorithm that concatenates template segments, feature-dependent clauses, and constraints derived from the preference indicator vector and user-specified parameters. This algorithm uses a rule set that maps particular preference features to explicit textual constraints, such as “short length,” “detailed explanations,” or “humorous tone.” By explicitly encoding such mappings, the server improves the consistency and technical predictability of prompt construction.

The server then sends the prompt sentence to the generative AI model using a network interface. The generative AI model is implemented, in one embodiment, as a transformer-based neural network with multiple layers of self-attention and feed-forward sub-networks. The generative AI model maintains a set of learned parameters including weight matrices and bias vectors for each layer. The generative AI model receives the prompt sentence as an input character string and converts it into a sequence of tokens according to a tokenizer such as a byte-pair encoding tokenizer. The generative AI model then maps each token to a numeric embedding vector using an embedding matrix and processes the sequence through the transformer layers.

The generative AI model computes, for each layer, attention scores between tokens, normalized by a scaling factor, and produces a weighted sum of value vectors for each token. The generative AI model then passes the resulting vectors through position-wise feed-forward networks with non-linear activation functions such as rectified linear units or gated linear units. At each generation step, the generative AI model applies a softmax transformation to obtain a probability distribution over the next token. The generative AI model selects the next token according to a sampling strategy such as top-k sampling or nucleus sampling, or according to a greedy decoding strategy, depending on parameters supplied by the server. The generative AI model repeats this operation until a maximum number of tokens is reached or an end-of-sequence token is generated. The generative AI model thus produces a sequence of tokens that is converted back into a text string as a content candidate.

The generative AI model is previously trained on a large corpus of text by minimizing a loss function such as cross-entropy between predicted token distributions and actual tokens. During training, the generative AI model updates its weight parameters using optimization algorithms such as stochastic gradient descent or variants such as Adam, with backpropagation to propagate gradients through the layers. The training process enables the generative AI model to encode language patterns and semantic relationships in a form that can be exploited in the generation process.

The server receives the generated content candidate from the generative AI model as part of a response structure. The server then performs post-processing operations. The server trims whitespace and normalizes newline characters. The server checks for content safety using one or more filters such as keyword-based filters, pattern-matching rules, or a separate classification model. The server may truncate the content to a maximum length specified in the user's request or inferred from the preference indicator vector. The server may further format the content, for example by inserting headings, paragraphs, or bullet lists when the content type is an article or a list.

The server then packages the post-processed content as response data in a structure interpretable by the terminal. This structure may include fields such as a title, a body, a theme, a creation time, and one or more metadata attributes that correspond to style or length. The server transmits this response data to the terminal via the network interface.

The terminal receives the response data and parses it into memory. The terminal then updates its user interface to present the content in a user display area. For example, the terminal may display a title in a header region and display the body of the content in a scrollable text region. The terminal uses its graphics subsystem to render text with appropriate fonts and layouts. The terminal may provide additional controls such as buttons labeled “Regenerate,” “Change style,” or “Suggest new themes.”

The user views the content on the terminal and may initiate further user operations. The user may, for example, press the “Regenerate” button to request another story with the same theme, or select a “More humorous” style option to request that the server modify the tone. The user may also select a “Recommend new themes” option to request that the server propose related themes for subsequent content generation.

The terminal converts these user operations into operation data including an action type, optional parameters such as a desired style or length, and context information such as identifiers of the content candidate currently shown. The terminal sends this operation data to the server.

The server receives the operation data and recognizes whether the operation corresponds to a regeneration instruction, a style change instruction, or a new theme proposal request. When the operation corresponds to a style change, the server may construct a new prompt sentence that incorporates the previously generated content or a summary of it. For example, the server may generate a prompt sentence such as:

“Here is an existing fantasy adventure story. Please rewrite it in a more humorous style while keeping the main plot and characters. Original story: [story text].”

When the operation corresponds to a new theme proposal request, the server applies the same preference indicator computation as before, but additionally uses aggregate usage tendency information from other users. The server may compute popularity scores for themes or tags using the storage device and select candidate themes that are both consistent with the user's preference indicator vector and highly ranked among other users. The server then generates a prompt sentence such as:

“The user frequently reads fantasy adventure and science fiction stories, and prefers deep philosophical themes and morally complex characters. Please propose three new reading themes that combine fantasy adventure with philosophical elements. For each theme, provide a short explanation and an example story idea.”

The server uses the generative AI model to generate recommendation information in response to such a prompt sentence. The server receives a list of theme descriptions and presents them as a list display on the terminal. The user can select one of these proposed themes, and the terminal sends the selection result back to the server. The server uses this selection result as new content of interest and repeats the prompt construction and generation process.

In one embodiment, the server maintains explicit data structures to improve computing efficiency and technical performance. The server stores usage history in relational tables with indexed columns for user identifiers, theme tokens, and timestamps, which accelerates queries for recent and frequent items. The server constructs preference indicator vectors using fixed-length arrays indexed by feature identifiers, enabling constant-time access to feature weights.

The server caches frequently used prompt templates and preference-derived text fragments in memory to reduce repeated string concatenation operations. These structural and algorithmic choices reduce processing time and memory usage compared to systems that build prompts in an ad-hoc, on-demand manner without pre-defined data structures.

The server reduces communication load by generating prompts and performing post-processing on the server side, thus sending only essential request and response data between the server and the terminal, rather than transmitting raw interaction logs or large unstructured texts. The server can compress response data or apply pagination to further reduce network bandwidth usage. These measures contribute to technical effects such as reduced latency and improved throughput for content generation services.

The server improves the operation of the generative AI model by supplying prompts that encode user preference indicators in a structured and consistent form. Because the server explicitly encodes features such as genre, style, and length into the prompt sentence according to a rule-based mapping algorithm, the generative AI model receives more precise conditioning information. This reduces the need for repeated trial-and-error requests by the user and increases the likelihood that a single generation produces a satisfactory result. As a consequence, the system reduces the number of invocations of the generative AI model per satisfactory output, thereby saving computational resources and reducing processing time.

The server also improves content management by linking a generated content candidate and its underlying preference indicator vector, prompt sentence, and user operation history in the storage device. This linkage allows the server to perform future analysis and optimization, such as determining which prompt constructions yield high user satisfaction. Such analysis can be used to tune the rule-based mapping algorithm and to adjust preference weighting functions. This continuous feedback loop is specific to the computer-based architecture, and it enables the system to improve its performance over time without requiring manual rule tuning by human operators.

The generative AI model processes data in a way that differs from traditional rule-based human workflows. The generative AI model performs high-dimensional vector operations, multi-head attention computations, and probabilistic token selection based on learned parameters, which are not directly interpretable as explicit human-written rules. The server, however, imposes non-conventional control over the generative AI model by adjusting decoding parameters such as temperature, top-k threshold, or nucleus probability in response to preference indicators. For example, the server may lower the temperature parameter for a user who prefers predictable, informative content, thereby reducing variance in generated outputs and improving perceived accuracy. Conversely, the server may increase the temperature parameter and allow more diverse token selection for a user who prefers creative or surprising content. Such parameter control constitutes a technical mechanism for controlling the behavior of the generative AI model at generation time.

In another embodiment, the server may implement a variation in which the generative AI model runs on the same physical machine as the server. In this case, the server's processor executes both the application logic and the generative model inference engine. The server may use hardware acceleration such as a local graphics processing unit or an accelerator card to execute matrix multiplications and attention computations more quickly. The server may also support a smaller, fine-tuned generative AI model that is optimized for a specific domain such as educational content or technical documentation, thereby achieving lower latency and reduced resource usage.

In yet another embodiment, the terminal may perform a subset of the preference analysis or user interaction processing. For example, the terminal may locally score recent user interactions to compute short-term preference indicators and send them to the server. This hybrid approach reduces the volume of raw interaction data transmitted to the server, thereby lowering communication overhead, while still enabling the server to maintain a comprehensive preference model using long-term data stored centrally.

The described embodiments demonstrate that the server, the terminal, and the generative AI model cooperate not only to automate content creation but also to improve the technical operation of the computer system itself. By structuring data, defining explicit algorithms for preference inference and prompt construction, and controlling neural network generation parameters in response to computed indicators, the system achieves technical effects including faster convergence to desired content, reduced computational waste, improved memory usage, and lower communication load. These effects arise from the specific configuration and processing steps executed within the computer system, rather than from mere automation of a human mental process.

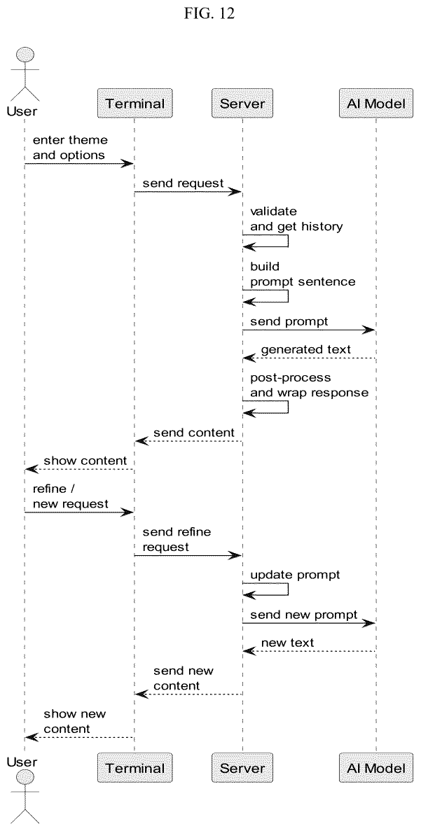

The following describes the processing flow using FIG. 12.
Step 1:

The user operates the terminal to input a content of interest and related parameters.

The user provides input such as a theme text (e.g., “fantasy adventure”), an optional content type (e.g., “story” or “article”), and optional constraints (e.g., “short,” “humorous,” “English”).

Input: raw user actions (taps, keystrokes) and textual theme data.

Output: a set of user input values held in the terminal's memory (theme, content type, constraints, user ID).

The terminal processes these actions by capturing events from the input device, placing the text into an input field, and reading the field values into variables once the user activates a submit control.
Step 2:

The terminal converts the user input values into structured request data and sends the data to the server.

The terminal constructs a data record including a user identifier, a theme string, a content type identifier, and constraint flags, and encodes this record into a structured format.

Input: user input values stored in terminal variables (user ID, theme, content type, constraints).

Output: a structured request packet transmitted to the server via a communication interface.

The terminal performs data processing by mapping each input value to a predefined field name, serializing the record into a message body, attaching protocol headers, and invoking the network stack to send the message.
Step 3:

The server receives the structured request packet and validates the contained fields.

The server reads the request from a network buffer, parses the structured format, and verifies that mandatory fields are present and within allowed ranges (for example, maximum length of the theme string).

Input: structured request packet received over a network connection.

Output: a validated request object stored in server memory, or an error status if validation fails.

The server performs data processing by checking string lengths, allowed character sets, and presence of required identifiers, and by creating an internal object or record that represents the validated request.
Step 4:

The server retrieves past usage history information for the user and aggregates it into a usable form.

The server uses the user identifier from the validated request to query a storage device for records of prior themes, ratings, interaction outcomes, and tags.

Input: validated request object including user identifier.

Output: a collection of past usage records loaded into an in-memory data structure.

The server executes data operations by issuing database queries, iterating over query results, and storing each result row into an array or list for subsequent analysis.
Step 5:

The server computes a preference indicator vector based on the content of interest and the past usage records.

The server extracts features such as genres, styles, and length preferences from the past records and the current theme, then computes numerical scores for each feature.

Input: content-of-interest string from the request and a collection of past usage records.

Output: a preference indicator vector, where each dimension denotes a feature weight (for example, fantasy score, humorous style score, short-length preference score).

The server performs data processing by tokenizing theme and tag strings, counting occurrences, calculating weighted averages of ratings, normalizing values to a fixed range, and writing the resulting scores into a fixed-length array indexed by feature IDs.
Step 6:

The server selects a prompt template appropriate for the requested content type and constructs a base prompt sentence.

The server identifies whether the user requested narrative content, explanatory content, or recommendation content, and loads a corresponding template string.

Input: content type from the validated request and preference indicator vector.

Output: a base prompt sentence skeleton that defines the general structure of the generative AI request.

The server performs data operations by comparing the content type field to predefined values, retrieving a stored template, and preparing placeholders within the template for theme and preference phrases.
Step 7:

The server enriches the base prompt sentence with feature-specific clauses derived from the preference indicator vector and request constraints.

The server determines which preference features exceed thresholds and appends descriptive clauses to the prompt sentence, such as “strong female protagonists,” “detailed world-building,” or “short, concise explanation.”

Input: base prompt sentence skeleton, preference indicator vector, and request constraints.

Output: a finalized prompt sentence in natural language for the generative AI model.

The server performs data processing by scanning each dimension of the preference vector, applying rule-based mappings from high-scoring features to textual phrases, generating length and style constraints, and concatenating these segments with the base sentence.
Step 8:

The server sends the prompt sentence to the generative AI model and configures generation parameters.

The server packages the prompt sentence and associated parameters (for example, maximum token count, temperature, and sampling strategy) into a generative model request.

Input: finalized prompt sentence and configuration settings derived from the request and preferences.

Output: a generative model request transmitted to the generative AI model over a network or an internal interface.

The server performs data processing by encoding the prompt text into a request structure, assigning numerical values to parameters that control randomness and length, and invoking an application programming interface to send the request.
Step 9:

The generative AI model generates a content candidate based on the prompt sentence using a transformer-based neural network.

The generative AI model tokenizes the prompt sentence, converts tokens into embeddings, processes them through multiple attention layers, and outputs a sequence of tokens representing the generated content.

Input: prompt sentence and generation parameters from the server.

Output: a generated token sequence converted into a text string as a content candidate.

The generative AI model performs data operations by computing matrix multiplications for attention and feed-forward layers, applying non-linear activation functions, computing probability distributions over tokens with a softmax function, sampling or selecting tokens according to configured parameters, and joining tokens into a final text string.
Step 10:

The server receives the content candidate from the generative AI model and parses the result.

The server extracts the generated text field from the model's response structure and stores it in memory.

Input: model response structure containing generated text and status metadata.

Output: a raw content candidate string and associated metadata stored in a server variable or record.

The server performs data processing by reading response fields, handling any error codes, and mapping the generated text into internal data structures for further processing.
Step 11:

The server performs post-processing on the content candidate to prepare it for presentation.

The server trims whitespace, normalizes line breaks, optionally removes or replaces disallowed expressions, and may adjust length by truncating or splitting the content.

Input: raw content candidate string and metadata such as desired length and safety policies.

Output: a post-processed content string suitable for display and compliant with system policies.

The server executes data operations by running string manipulation functions, applying filtering rules or pattern checks, and, if necessary, cutting the content at sentence boundaries to respect length constraints.
Step 12:

The server converts the post-processed content into response data in a format interpretable by the terminal.

The server attaches metadata such as title, theme, creation time, and content type, and assembles these into a structured response record.

Input: post-processed content string and internal metadata values.

Output: a structured response message containing content and metadata for transmission.

The server performs data processing by creating key-value pairs, assigning content to specific fields, and serializing this structure into a transfer format.
Step 13:

The server transmits the response message to the terminal through the network interface.

The server sends the structured response using a communication protocol, ensuring proper headers and status codes.

Input: structured response message created in server memory.

Output: a response packet delivered to the terminal's network stack.

The server executes operations by writing the message to a network socket, managing connection state, and confirming successful transmission or handling retransmission in case of temporary network issues.
Step 14:

The terminal receives the response packet and reconstructs the response data.

The terminal parses the structured response, extracts the title, content body, and associated metadata, and places them into local variables.

Input: response packet received via the terminal's network interface.

Output: parsed response elements (title string, content body string, metadata) stored in terminal memory.

The terminal performs data processing by decoding the message, mapping fields to internal data structures, and detecting any error status or special display instructions.
Step 15:

The terminal updates the user interface to display the generated content to the user.

The terminal sets a display component for the title, fills a scrollable text area with the content body, and arranges any additional information such as tags or timestamps.

Input: parsed response elements from terminal memory.

Output: rendered visual representation of the content on the display device.

The terminal performs graphical operations by computing layout positions, applying font and color settings, and issuing drawing commands to the graphics subsystem so that the user can read and scroll through the content.
Step 16:

The user reviews the displayed content and optionally performs an additional operation such as regeneration, style change, or new theme request.

The user interacts with visible controls, for example by tapping “Generate again,” selecting a style like “more humorous,” or pressing a “Recommend new themes” button.

Input: displayed content and control elements on the terminal screen.

Output: a new user action pattern that the terminal translates into a refined request.

The user's operation causes the terminal to capture a new event, which becomes the basis for further program processing.
Step 17:

The terminal converts the additional user operation into refinement or recommendation request data and sends it to the server.

The terminal determines the action type (regenerate, change style, request recommendation), attaches context such as current theme and content identifier, and packages these into structured request data.

Input: user operation event and current display context data.

Output: a refinement or recommendation request packet transmitted to the server.

The terminal performs data operations by mapping action types to predefined codes, adding optional parameters (for example, “more humorous,” “shorter length”), and invoking the network interface to send the structured request.
Step 18:

The server receives the refinement or recommendation request and updates the prompt sentence accordingly.

The server inspects the action type and parameters, may re-use the previous content candidate or summarize it, and constructs a new or modified prompt sentence that reflects the requested change or recommendation.

Input: refinement or recommendation request packet, previous prompt sentence, and optionally previous content candidate.

Output: an updated prompt sentence that incorporates style adjustments, new constraints, or recommendation instructions.

The server performs data processing by merging the new parameters into the existing preference indicator vector, selecting appropriate transformation rules (for example, “rewrite in humorous style” or “propose new themes”), editing template text to include references to prior content if needed, and producing a new prompt sentence string, which is then supplied again to the generative AI model using the same mechanism as in earlier steps.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information provision systems that utilize machine learning or rule-based engines typically generate responses in a static manner based only on the most recent user input, or by applying simple keyword matching to a collection of predefined templates. In such systems, a processor often treats user messages as isolated requests and does not effectively exploit accumulated past user information, such as historical messages, previous selections, and behavioral tendencies. As a result, the system fails to generate context-aware prompt sentences for a generative AI model and therefore cannot fully leverage the capabilities of the generative AI model to infer user preferences or to propose optimized information. This leads to suboptimal personalization, lower relevance of proposals, and increased user interaction cost, because the user must repeatedly provide explicit preference information or manually filter irrelevant options.

Furthermore, in many existing architectures, the generation of a natural-language prompt for a generative AI model is implemented as an ad-hoc layer outside the core system logic, without structured use of stored preference data and without feedback loops from past AI outputs. Such architectures hinder the ability to dynamically adapt the content of prompt sentences according to evolving user preferences. As the number of users and the volume of interaction logs increase, these systems exhibit scalability issues, including redundant data processing, repetitive queries to external information sources, and inefficient orchestration between preference inference, candidate retrieval, and action execution. This degrades system performance and responsiveness.

Additionally, conventional systems that provide recommendations or suggestions often require the user to leave the recommendation environment and perform subsequent reservation or purchase actions via separate applications or web sites. This fragmented user experience imposes additional cognitive and operational overhead on the user and prevents seamless transition from information proposal to concrete transaction. In terms of computer technology, such fragmentation forces separate processing pipelines and redundant network communications, resulting in increased latency and complexity in coordinating external transaction systems.

Accordingly, there is a need for an improved computer-implemented system that (i) automatically analyzes both current and past user inputs to infer user preferences in a structured manner, (ii) programmatically generates and updates prompt sentences for a generative AI model based on those structured preferences and on real-time candidate information from external information sources, and (iii) directly couples the generated response content with executable transaction flows such as reservation or purchase processes. Such a system should improve the technical functioning of the server by reducing repeated manual input, optimizing data retrieval and filtering operations, and enabling a unified control flow from natural-language interaction to transaction execution within a single computing architecture.

The specific processing by the specific processing unit 290 of the data processing device 12 in Example 2 is realized by the following means.

The present invention provides a server comprising a processor configured to receive information input from a user terminal and store the information input in a storage device, detect a specific phrase included in the information input by performing language analysis on the information input, upon detection of the specific phrase acquire past information related to a user from the storage device and generate analysis data by integrating the past information, generate a prompt sentence based on the analysis data and the information input so as to cause a generative AI model to infer a preference or a behavioral tendency of the user, input the prompt sentence to the generative AI model to obtain estimation information regarding the preference or the behavioral tendency of the user, acquire candidate information that is currently available from an external information providing apparatus, select proposal information suitable for the user based on the candidate information and the estimation information, generate a further prompt sentence for causing the generative AI model to generate response content that presents the proposal information to the user terminal, input the further prompt sentence to the generative AI model to generate the response content, structure preference information of the user based on the estimation information and update and store the structured preference information in the storage device so that subsequent prompt sentences are dynamically modified by referring to the preference information, and acquire transaction information or procedure information associated with the proposal information from an external processing apparatus, present options based on the transaction information or the procedure information together with the response content on a user interface of the user terminal, receive a selection from the user via the user terminal, and transmit a request for executing a reservation process or a purchase process to the external processing apparatus according to the selection. This enables the server to technically improve the processing of user interactions by automatically transforming unstructured, multi-turn user inputs and historical data into structured preference information, by generating and adapting prompt sentences for the generative AI model in a data-driven manner, by filtering and combining external candidate information using the inferred preferences, and by integrating recommendation generation with executable transaction flows, thereby reducing redundant user input, network calls, and application switching, and increasing the efficiency, responsiveness, and personalization accuracy of the overall computer system.

The term “processor” refers to a hardware-implemented information processing unit, such as a central processing unit or a combination of processing circuits, configured to execute program instructions to realize the functions described in the present specification.

The term “user terminal” refers to an information processing device operated by a user, such as a portable terminal, a desktop device, or any network-capable client device, that is configured to transmit information input to, and receive information output from, the server.

The term “information input” refers to data supplied from the user terminal to the server, including at least a natural-language message or other user-provided content to be processed by the processor.

The term “storage device” refers to a non-transitory computer-readable medium, such as a magnetic storage device, a solid-state storage device, or a memory device, that stores information input, past information, preference information, and other data used by the processor.

The term “specific phrase” refers to a word, a term, or a combination of words or terms included in the information input that is predefined as a trigger for causing the processor to perform particular processing, such as preference inference or candidate information retrieval.

The term “language analysis” refers to processing performed by the processor to analyze a character string of the information input, such as tokenization, morphological analysis, syntactic analysis, or keyword extraction, in order to detect the specific phrase.

The term “past information” refers to information related to the user that has been previously stored in the storage device, including at least past information inputs, historical interaction logs, or past selection records.

The term “analysis data” refers to data generated by the processor by combining, integrating, or organizing the past information and optionally the current information input for use in further processing such as preference inference.

The term “prompt sentence” refers to a natural-language instruction or query generated by the processor and provided as input to a generative AI model in order to cause the generative AI model to perform a specified inference or generation task.

The term “generative AI model” refers to a machine-learned model that generates output data, such as natural-language text, in response to input data including at least a prompt sentence, and that is implemented by using a trained parameter set executed on a computing resource.

The term “preference” refers to a tendency or inclination of the user toward particular categories, attributes, or types of items, such as content types, genres, or services, as inferred from the information input and the past information.

The term “behavioral tendency” refers to a characteristic pattern of actions or choices of the user, such as frequently selected options, typical time periods, or commonly used services, inferred from the information input and the past information.

The term “estimation information” refers to information output from the generative AI model in response to a prompt sentence, indicating an inferred preference or behavioral tendency of the user in a form that can be processed by the processor.

The term “candidate information” refers to information representing items or options that are currently available from an external information providing apparatus, such as listings, offers, or events that may be proposed to the user.

The term “external information providing apparatus” refers to a computer system or service, separate from the server, that supplies candidate information through a communication network in response to a request from the processor.

The term “proposal information” refers to one or more items selected by the processor from the candidate information based on the estimation information as being suitable for presentation to the user.

The term “response content” refers to information, including at least natural-language text, generated directly or indirectly by the generative AI model under control of the processor, and configured to present the proposal information to the user via the user terminal.

The term “preference information” refers to structured data representing the preference or behavioral tendency of the user, derived from the estimation information, and stored in the storage device for use in subsequent processing.

The term “transaction information” refers to data necessary for executing a commercial or service-related transaction associated with the proposal information, such as price information, availability information, or resource identifiers.

The term “procedure information” refers to data representing a sequence of actions, parameters, or options required to perform a process associated with the proposal information, such as reservation steps, registration steps, or application steps.

The term “external processing apparatus” refers to a computer system or service, separate from the server, that executes a process such as a reservation process or a purchase process based on a request transmitted from the processor.

The term “reservation process” refers to processing performed by the external processing apparatus to allocate or hold a resource, service slot, or item for the user in response to a request from the processor.

The term “purchase process” refers to processing performed by the external processing apparatus to complete an acquisition of a good, service, or right by the user, including at least confirmation of availability and completion of a transaction.

The term “user interface” refers to a presentation and input mechanism provided on the user terminal, such as a graphical user interface, through which the user views the response content and proposal information and inputs a selection or instruction.

In one embodiment, a server, a terminal, and a user cooperate to implement the invention. The server includes at least one processor, a main memory, a non-transitory storage device, a network interface, and, optionally, one or more hardware accelerators such as a graphics processing unit. The terminal includes a processor, a display, an input device such as a touchscreen, a memory, and a network interface. The user operates the terminal to interact with the server through a communication network such as the Internet.

The server executes an operating system such as a generic server operating system and an application program such as a web application implemented by a server-side framework (for example, a framework comparable to a Python-based web framework, a Java-based web framework, or a JavaScript-based web framework). The server further executes middleware such as an HTTP server that terminates HTTPS connections. The storage device of the server stores at least a message database, a user profile database, a preference database, a log database, and a model configuration repository.

The terminal executes an operating system such as a mobile operating system or a desktop operating system and a client application such as a dedicated messaging application or a web browser. The terminal uses a graphical user interface to display content received from the server and to capture user input in the form of natural-language text or touch gestures.

The server stores program instructions that, when executed by the processor, cause the server to receive information input from the terminal, to analyze the information input, to generate prompt sentences, to interact with a generative AI model, and to manage external information providing apparatuses and external processing apparatuses. The server implements modules such as a communication module, a language analysis module, an interaction history module, a prompt generation module, a generative AI client module, a candidate retrieval module, a preference structuring module, and a transaction orchestration module.

The server uses the language analysis module to process information input received from the terminal. The language analysis module uses a natural language processing library, which may be implemented as a tokenization and parsing engine, to transform the information input into a sequence of tokens and syntactic structures. The server stores the information input and the analysis result in the message database in the form of records containing at least a user identifier, a timestamp, a text field, a token list, and a detected keyword list. By storing both the raw text and structured analysis features, the server enables later computation that does not require repeated re-parsing of the same messages. This reduces processing overhead and improves response latency.

The server uses the interaction history module to retrieve past information for a given user from the message database and other databases. The server integrates the retrieved past information into analysis data by concatenating text segments and by aggregating metadata such as message categories and previously selected options. In one embodiment, the server stores the analysis data in a data structure represented as a sequence of segments, each segment including a message text, a timestamp, and categorized labels such as “movie-related,” “travel-related,” or “purchasing-related.” The server uses this structured analysis data as a basis for constructing prompt sentences that are sensitive to long-term user preferences.

The server uses the prompt generation module to create a prompt sentence for a generative AI model. The server constructs the prompt sentence as natural-language text that includes an instruction part and a context part. In one example, the server generates a prompt sentence for preference inference as follows:

“Analyze the following past user messages and infer the user's movie preferences. List the preferred genres and the disliked genres in a concise form.”

The server then appends the analysis data, such as a chronologically ordered list of past movie-related messages, below the instruction. The server uses delimiters such as “===PAST MESSAGES START===” and “===PAST MESSAGES END===” to clearly separate instructions from context. The server stores the generated prompt sentence in the log database to enable auditing and optimization of the prompt generation logic.

The server uses the generative AI client module to send the prompt sentence to a generative AI model. The generative AI model, in one embodiment, is a large-scale neural network implemented as a transformer-based architecture having multiple attention layers, feed-forward networks, and layer normalization components. The generative AI model is pre-trained on a large corpus and optionally fine-tuned on domain-specific data such as dialog data or recommendation logs. The server communicates with the generative AI model through a network API over HTTPS. The server includes in the API request parameters such as a model identifier, a temperature parameter for sampling, a maximum output length parameter, and a stopping criterion.

The server receives estimation information from the generative AI model as a natural-language output. The estimation information may include explicit genre names, preference scores, or summary descriptions. The server uses the preference structuring module to parse the estimation information and to convert it into preference information, which is stored as structured records in the preference database. In one embodiment, the server uses a controlled vocabulary of categories to map phrases such as “likes action movies” and “dislikes horror movies” to normalized codes such as “GENRE_ACTION=+1” and “GENRE_HORROR=−1”. The server also stores a confidence score for each preference, derived from the presence of explicit ranking words or from an evaluation model that processes the generative AI output. This structuring allows the server to perform efficient matching between user preferences and external candidate data using database queries and in-memory filtering rather than re-interpreting free text each time.

The server uses the candidate retrieval module to obtain candidate information from an external information providing apparatus. The external information providing apparatus is, for example, a remote server that provides items, services, or events. The server sends an HTTP request including query parameters such as location identifiers, time windows, and category filters. The external information providing apparatus returns candidate information as structured data, for example in a list of items with attributes such as titles, categories, identifiers, and availability times. The server parses this candidate information and stores it temporarily in an in-memory data structure, for example a list of records with indexed fields for fast lookup.

The server uses the preference structuring module and the candidate retrieval module in combination to compute a matching between candidate information and preference information. The server performs data processing such as computing a relevance score for each candidate item as a function of genre match, temporal proximity, and historical selection frequency. For example, the server computes a relevance score S for a candidate by weighting each preference code with a pre-defined or adaptively learned weight and summing over relevant attributes. The server may use a vector representation of preferences and candidate attributes and compute similarity using a cosine similarity metric or a dot product. The server selects top-ranked items as proposal information and stores them in a list in memory.

The server uses the prompt generation module again to construct a second prompt sentence that is intended to cause the generative AI model to generate response content suitable for the user. In one example, the server constructs the following prompt sentence: “The user wrote: ‘I want to plan a movie outing with my friends.’ The user likes action and sci-fi movies and dislikes horror. Based on the following currently available movies (each with title, genre, and showtime), generate a friendly recommendation message suggesting a few suitable movies and times.”

The server then appends the list of selected proposal information, each entry describing an item in a compact natural-language phrase, below the instruction. The server sends this second prompt sentence to the generative AI model. The generative AI model generates response content, for example a paragraph of text describing a small number of recommended items and their times. The server receives the response content and stores it along with the underlying proposal information.

The server uses the communication module to transmit the response content and the proposal information to the terminal. The terminal displays the response content in a messaging view or a recommendation panel. The terminal additionally renders the proposal information as selectable items, for example as buttons or list entries, each linked to transaction information that the server will later use to perform a reservation process or a purchase process.

The server uses the transaction orchestration module to communicate with an external processing apparatus when the user selects one of the options on the terminal. The server retrieves transaction information or procedure information associated with the selected proposal information from a database or from the external processing apparatus. The server constructs a transaction request message that complies with the external processing apparatus protocol, including parameters such as item identifiers, time slots, quantities, and payment identifiers.

The server sends the transaction request and receives a transaction result. The server then generates a confirmation message, which may be generated by template-based methods or with assistance of a generative AI model using a further prompt sentence such as:

“Generate a concise confirmation message informing the user that the reservation for [ITEM_TITLE] at [TIME] has been successfully completed.”

The server transmits the confirmation message to the terminal. The terminal displays the confirmation message and may additionally store identifiers such as reservation numbers. The user can verify the completion of the reservation or purchase by viewing the displayed confirmation.

The server improves computer technology by integrating long-term interaction history, structured preference information, and dynamic prompt sentence generation into a unified processing pipeline. The server uses specific data structures such as indexed tables for messages, preferences, and candidates, and uses scoring algorithms and vector computations to reduce the number of candidate items to be considered. This reduces the amount of data that must be included in prompt sentences, thereby reducing network bandwidth usage and response time for the generative AI model. The server further avoids repeatedly sending the full interaction history by maintaining a structured representation of preferences and by updating only incremental changes. This technique decreases redundant computation and improves throughput.

The generative AI model itself is implemented as a neural network that uses a transformer architecture with multi-head attention layers. During training, the model uses a loss function such as cross-entropy between predicted tokens and ground truth tokens. The weights of the model are updated using an optimization algorithm such as stochastic gradient descent with momentum or adaptive gradient methods. The server may further fine-tune the generative AI model on a dataset of historical dialog and recommendation outcomes by minimizing an objective function that penalizes deviations from desired recommendation style or accuracy. The server stores model parameters and training metadata in the storage device. By explicitly disclosing these model structures and training mechanisms, the system is not limited to an abstract “AI decides” description, but instead uses specific architectural and algorithmic components that can be implemented and executed on actual computing hardware.

The server, in some embodiments, uses feature engineering or representation learning techniques to improve the accuracy of preference inference. For example, the server may compute embeddings of user messages using the generative AI model or a separate encoder network and cluster these embeddings to discover latent preference groups. The server then uses cluster assignments as additional features in the preference information records. This allows the server to perform more precise matching between user preferences and candidate information, leading to improved quality of generated recommendations while maintaining computational efficiency.

The server is configured so that AI-based processing is not a mere automation of human tasks, but a technical mechanism that restructures data and processing flows in ways that a human operator could not feasibly replicate at scale. The server uses specific algorithms that combine multi-turn message history, structured preference codes, and real-time external data in an adaptive prompt generation process. This reduces user errors, avoids repetitive manual input, and enables faster discovery of relevant options. In terms of technical effect, the system reduces server-side CPU usage by avoiding repeated re-analysis of entire histories, reduces memory bandwidth by using compact structured representations, and reduces network traffic by limiting the size of API calls to the generative AI model and to external information providers.

The server can be implemented in multiple variations. In one variation, the generative AI model is executed on a remote AI service platform, and the server interacts with it via an API. In another variation, the generative AI model is executed locally on the same hardware as the server or on a dedicated inference server with specialized hardware accelerators. In another variation, the terminal includes a local lightweight model to perform part of the language analysis and to offload some computations from the server. The system can also use different types of external information providing apparatuses and external processing apparatuses, such as content servers, ticketing systems, or resource allocation systems.

The server can additionally implement caching strategies for candidate information and preference information. When the server detects that multiple users in the same region request similar information, the server retrieves candidate information only once and reuses it while applying different preference filters for each user. This reduces the number of external API calls, thereby lowering communication load and improving overall system throughput.

The server can further implement alternative preference inference strategies. For example, in one embodiment, the server generates separate prompt sentences for different preference dimensions, such as genre preference, time preference, and location preference, and combines the resulting estimation information into a multi-dimensional preference vector. In another embodiment, the server uses an ensemble approach where the output of the generative AI model is combined with the output of a rule-based engine that enforces business constraints or safety rules. These variations allow the system to be adapted to different application domains while sustaining the technical improvements in data processing, accuracy, and computational efficiency.

In summary, the server, the terminal, and the user cooperate so that the server receives and stores information input, performs structured language analysis and history integration, generates specialized prompt sentences for a generative AI model, transforms the AI outputs into structured preference information, retrieves and filters candidate information from external sources, generates tailored response content, and orchestrates transaction execution. This architecture provides concrete technical mechanisms that improve the operation of the underlying computer system beyond a mere abstract idea or business method, by enhancing data management, computational efficiency, and adaptive personalization based on the integrated use of generative AI model outputs and structured preference representations.

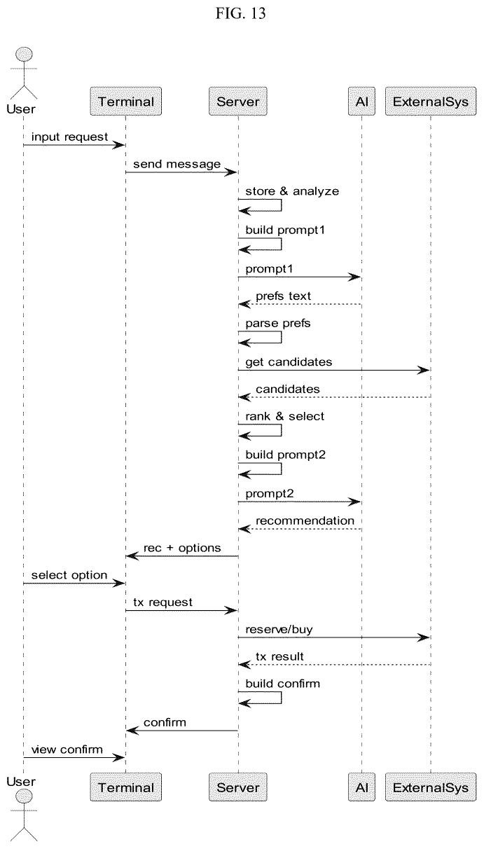

The following describes the processing flow using FIG. 13.
Step 1:

The user operates the terminal to launch a client application and to input an information message.

The input is a natural-language text string such as “I want to plan a movie outing with my friends,” entered via a keyboard or touchscreen.

The terminal captures the text string, adds a user identifier and a timestamp, and performs basic validation such as checking that the text is non-empty.

The terminal outputs a structured request object that includes the user identifier, the message text, and metadata, and transmits this object to the server via an HTTP request over a network.
Step 2:

The server receives the HTTP request from the terminal and stores the raw message.

The input is the structured request object containing the user identifier, message text, and metadata.

The server uses an HTTP server and an application framework to parse the request, extract the message text and user identifier, and write a new record into a message table in a storage device.

The server outputs a stored message record that includes fields such as message_id, user_id, timestamp, and raw_text.
Step 3:

The server performs language analysis on the stored message to detect specific phrases.

The input is the message record containing the raw_text field.

The server applies a natural language processing library to tokenize the text, perform part-of-speech tagging, and optionally perform dependency parsing, then scans the resulting tokens for predefined keywords such as “movie,” “schedule,” or “reservation.”

The server outputs an analysis record that includes the original message_id, a token list, and a list of detected specific phrases.
Step 4:

The server determines whether the message contains a specific phrase that should trigger preference-based processing.

The input is the analysis record with the detected specific phrases.

The server compares each detected phrase against a configured trigger list stored in a configuration table, and performs a logical evaluation to determine whether one or more trigger conditions are satisfied.

The server outputs a trigger decision flag and, if triggered, a trigger type value such as “MOVIE_PLANNING.”
Step 5:

The server retrieves past information for the user when a trigger condition is satisfied.

The input is the trigger decision flag, the trigger type, and the user_id from the message record.

The server queries the message table and related tables for past messages associated with the same user_id, optionally filtering by trigger type (for example, movie-related messages), and orders the results chronologically.

The server outputs a collection of past message records containing text fields and associated metadata for the user.
Step 6:

The server generates analysis data by integrating the past information and the current message.

The input is the collection of past message records and the current message record.

The server concatenates selected message texts into a single composite text block, inserts separators and timestamps, and may add labels such as “[PAST MESSAGE]” or “[CURRENT MESSAGE]” before each segment; the server may also compute statistics such as frequency counts of genre terms.

The server outputs integrated analysis data that includes a composite text block and derived summary features for the user.
Step 7:

The server constructs a first prompt sentence for preference inference based on the analysis data.

The input is the integrated analysis data including the composite text block and summary features.

The server generates a natural-language instruction such as “Analyze the following past user messages and infer the user's movie preferences. List the preferred genres and the disliked genres in a concise form.” and appends the composite text block between explicit delimiters.

The server outputs a first prompt sentence that is formatted as a single text string ready to be sent to a generative AI model.
Step 8:

The server sends the first prompt sentence to a generative AI model and obtains estimation information.

The input is the first prompt sentence text string.

The server constructs an API request payload including the prompt sentence and parameters such as temperature and maximum token count, transmits the payload over HTTPS to an AI service endpoint, and waits for a response; the AI model applies its transformer-based neural network to generate a textual output describing user preferences.

The server outputs estimation information, received as a text response, that expresses inferred preferences and possibly behavioral tendencies of the user.
Step 9:

The server structures the estimation information into normalized preference information.

The input is the textual estimation information from the generative AI model.

The server parses the text, identifies explicit genre or category terms (for example, “action,” “science fiction,” “horror”), and maps them to normalized codes using a predefined dictionary, optionally assigning positive or negative flags and confidence values; the server then creates or updates preference records linked to the user_id.

The server outputs structured preference information stored in the preference database, including fields such as genre_code, polarity, and confidence_score.
Step 10:

The server acquires current candidate information from an external information providing apparatus.

The input is the user_id, the trigger type, and optional parameters such as location or time range derived from user settings.

The server composes an HTTP request to an external information source, including filter parameters, and sends the request; upon reception, the server parses the returned structured data, such as a list of items with titles, category identifiers, and availability times.

The server outputs a candidate list comprising multiple candidate entries with normalized attributes.
Step 11:

The server filters and ranks the candidate information using the structured preference information.

The input is the candidate list and the structured preference information for the user.

The server matches candidate attributes, such as genre identifiers, against preferred and disliked codes in the preference records, computes a relevance score for each candidate using an evaluation function (for example, a weighted sum of genre matches and time proximity), and sorts candidates by the computed score; candidates below a threshold are discarded.

The server outputs a sorted list of proposal candidates that are deemed suitable for the user, each annotated with its relevance score.
Step 12:

The server selects proposal information from the ranked candidates.

The input is the sorted list of proposal candidates.

The server selects a subset of top-ranked candidates, optionally subject to constraints such as maximum number or diversity of genres, and forms proposal information entries that include only the necessary attributes for presentation (for example, title, category name, and main time slot).

The server outputs a proposal information list for use in generating user-facing content.
Step 13:

The server constructs a second prompt sentence to cause the generative AI model to generate response content that presents the proposal information.

The input is the proposal information list, the structured preference information, and the original current message.

The server composes an instruction text such as “The user wrote: ‘I want to plan a movie outing with my friends.’ The user likes action and sci-fi movies and dislikes horror. Based on the following currently available movies (each with title, genre, and showtime), generate a friendly recommendation message suggesting a few suitable movies and times.” and then appends a description of each proposal item in a compact line format.

The server outputs a second prompt sentence that integrates user preferences, current intent, and specific candidate items as a single text string.
Step 14:

The server sends the second prompt sentence to the generative AI model and obtains response content.

The input is the second prompt sentence text string.

The server wraps the prompt into an API request, transmits it to the AI endpoint, and receives a generated natural-language text that describes and recommends one or more proposed items; internally, the model uses its learned parameters to select words and construct coherent sentences conditioned on the prompt.

The server outputs response content as a text message that is suitable for direct presentation to the user.
Step 15:

The server packages the response content together with the underlying proposal information and sends them to the terminal.

The input is the response content text and the proposal information list.

The server builds a response object containing the natural-language recommendation and a structured list of proposal items with identifiers, titles, and times, serializes this object into a response format such as JSON, and transmits it to the terminal over HTTPS.

The server outputs a network response that the terminal can parse and use to render both text and interactive options.
Step 16:

The terminal receives and displays the response content and the proposal information.

The input is the network response containing the recommendation text and the structured proposal list.

The terminal parses the response, displays the recommendation text in a message area, and renders each proposal item as a selectable UI component such as a list entry with a title, genre, time, and a “Reserve” or “Buy” button.

The terminal outputs a graphical user interface state in which the user can understand the recommended options and select one of them.
Step 17:

The user reviews the presented options and selects a desired proposal.

The input is the graphical user interface containing displayed proposal items.

The user reads the textual recommendation, inspects the list of items and their details, and taps or clicks a specific proposal item or an associated action button to indicate a selection.

The user outputs a selection action that the terminal captures as an event including at least the identifier of the selected proposal item.
Step 18:

The terminal sends a transaction request to the server based on the user's selection.

The input is the selection event containing the proposal item identifier and any additional user-specified parameters such as quantity or preferred seat type.

The terminal constructs a new HTTP request that includes the user identifier, the selected item identifier, and transaction parameters, and transmits this request to the server over the network.

The terminal outputs a structured transaction request destined for the server.
Step 19:

The server initiates a transaction process with an external processing apparatus.

The input is the transaction request containing the selected item identifier and transaction parameters.

The server retrieves transaction or procedure information associated with the selected proposal from a database or external API, constructs a standardized transaction message including resource identifiers, time slots, and requested quantities, and sends this message to an external processing apparatus such as a reservation or purchasing system.

The server outputs a transaction call and receives a transaction result indicating success, failure, or required modification.
Step 20:

The server generates a confirmation message based on the transaction result.

The input is the transaction result received from the external processing apparatus.

The server examines fields such as status code, reservation number, and confirmed time, and, if successful, either applies a message template or sends a short prompt sentence (for example, “Generate a concise confirmation message informing the user that the reservation for [ITEM_TITLE] at [TIME] has been successfully completed.”) to the generative AI model to obtain a natural-language confirmation; the server then binds the reservation number and item details into the resulting text.

The server outputs a finalized confirmation message text and structured confirmation data including identifiers.
Step 21:

The server transmits the confirmation message and confirmation data to the terminal.

The input is the confirmation message text and the associated confirmation data.

The server encapsulates this information into an HTTP response or push message and sends it to the terminal, optionally updating internal logs and user history tables with the executed transaction details.

The server outputs a confirmation response that can be rendered by the terminal.
Step 22:

The terminal displays the confirmation to the user.

The input is the confirmation response containing the confirmation message and confirmation data.

The terminal parses the response, displays the confirmation message prominently in the user interface, and may show additional details such as reservation number, date, time, and location, optionally offering UI controls to add the event to a calendar or share the confirmation.

The terminal outputs an updated graphical interface that allows the user to verify that the reservation or purchase has been successfully executed.
Step 23:

The server updates the user's historical and preference information based on the completed transaction.

The input is the transaction details and the user identifier.

The server writes a new record into a history table indicating that the user selected and completed a transaction for the particular item, and updates preference information by incrementing counters or adjusting weights for categories associated with the selected item; the server may also store a marker that future prompt sentences should emphasize similar items.

The server outputs updated history and preference records that influence subsequent analysis data and prompt sentence generation.
Step 24:

The server logs the prompts and AI outputs for subsequent optimization of the processing pipeline.

The input is the first prompt sentence, the second prompt sentence, the estimation information, and the final response content generated in the interaction.

The server stores these texts and related context in a log database, along with performance metrics such as response times and user selection outcomes, and later processes these logs offline or in batch mode to refine prompt templates, parameter settings, and ranking algorithms.

The server outputs improved configuration data and refined prompt generation rules that are used in future executions to enhance accuracy, speed, and resource efficiency.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional computer-implemented information provision and transaction systems, a computing device typically responds to user input by executing a fixed rule set or by invoking a generative AI model with a static, manually designed prompt. Such systems exhibit several technical deficiencies. First, the processor often treats the user's current message in isolation, without systematically integrating heterogeneous contextual data such as historical usage records, inferred user preferences, and emotion information. As a result, the processor generates generic outputs that are poorly aligned with user behavior patterns, which leads to unnecessary repeated interactions, additional network round trips, and excessive computation on both the application layer and backend resources.

Second, known systems usually invoke a generative AI model using prompts that are either hard-coded or minimally parameterized. These prompts do not explicitly encode machine-usable constraints such as output format, number of items, or tone, and do not dynamically reflect current preference models or emotion states that are stored and updated in a data store. Consequently, the generative AI model tends to produce responses that are verbose, unfocused, or difficult to map back to concrete items in external information sources, such as content catalogs, reservation services, or settlement services. From a computer technology perspective, this results in additional parsing logic, complex post-processing pipelines, and redundant calls to external services, which increase processor load and memory consumption.

Third, typical systems do not provide a tightly integrated processing loop that connects (i) prompt generation, (ii) response analysis and item resolution against external candidate sets, (iii) execution of reservation or purchase procedures, and (iv) feedback of the user's ultimate selection results into the prompt-generation and preference-estimation logic. Without such a loop, the processor cannot efficiently refine its internal models or adjust future prompts based on real-world outcomes. This limits the system's ability to converge toward more accurate first-pass proposals, causing repeated interactions and inefficient use of bandwidth, storage, and compute resources.

Fourth, the user interface layer in conventional architectures generally treats AI-generated text as passive content. It does not systematically use structured proposal information, in which each AI-referenced item is linked to identifiers, times, locations, and prices, to render actionable controls that can trigger backend processes in a single user operation. As a result, the user must navigate multiple screens and perform multiple input steps, while the processor must repeatedly validate context and re-fetch data. This increases latency, raises error rates, and complicates the implementation of the user interface and backend orchestration logic.

Accordingly, there is a need for an improved computer-implemented system in which a processor dynamically constructs context-aware prompt sentences for a generative AI model by combining intent information, keyword information, user preference information, and emotion information; structurally resolves AI-generated responses against external candidate data; surfaces those results to a user interface as structured proposal information with directly actionable options; and feeds the user's selections back into prompt-generation rules and preference-estimation models. Such a system should reduce unnecessary computation and network transactions, improve the precision and usefulness of first-pass AI responses, and streamline the end-to-end interaction flow in a technically efficient manner.

The specific processing by the specific processing unit 290 of the data processing device 12 in Application Example 2 is realized by the following means.

The present invention provides a server comprising a processor and a storage device, the processor being configured to receive information input from a user via a user interface of a terminal device and store the information input in the storage device together with user identification information; analyze the information input to extract intent information and keyword information, acquire past usage history information associated with the user identification information from the storage device, and estimate user preference information based on the past usage history information; identify emotion information included in the information input by using an emotion analysis function or an external emotion analysis service, and store the emotion information in the storage device in association with the user identification information; generate, based on the intent information, the keyword information, the user preference information, and the emotion information, a prompt sentence including instruction content that specifies at least an output format, an output number of items, and an output tone, and cause a generative AI model to generate a response candidate by inputting the prompt sentence into the generative AI model; analyze the response candidate to identify a referred target item, compare the referred target item with a candidate information set acquired from an external information providing device, and generate structured proposal information in which the referred target item is associated with at least one of identifier information, price information, time information, and location information; present the structured proposal information to the user via the user interface and present, in association with each target item included in the structured proposal information, at least one operation option for executing a reservation process, a purchase process, or a reproduction process; accept a selection operation performed by the user with respect to at least one of the operation options, execute at least one of the reservation process, the purchase process, and the reproduction process by communicating with at least one of an external settlement device and an external reservation device, and store a result of the executed process as updated usage history information in the storage device; and update a prompt generation rule and a preference estimation model stored in the storage device on the basis of at least one of past prompt sentences, past response candidates, and past selection results by the user, and dynamically adjust future content of the prompt sentence generated for subsequent information input. This enables the server to technically improve the end-to-end information processing pipeline by reducing redundant generative AI calls and external service queries through context-rich prompt sentences, by converting AI output into structured proposal information that can be executed with a single user operation, and by continuously refining internal prompt-generation rules and preference-estimation models based on actual user selections, thereby improving computational efficiency, lowering latency, and enhancing the accuracy and actionability of system responses in a computer-centric manner.

The term “processor” refers to a hardware or virtual computation unit, such as a central processing unit or a processing core in a computing environment, that executes machine instructions to perform analysis, generation, communication, and control operations defined by program code.

The term “storage device” refers to a hardware or virtual data-holding resource, such as a memory device or a persistent storage subsystem, that stores information including user identification information, usage history information, emotion information, prompt sentences, response candidates, rules, and models in a machine-readable form.

The term “terminal device” refers to a computing apparatus operated by a user, such as a communication device or a display-equipped device, that provides an interface for inputting information and receiving responses from a remote system.

The term “user interface” refers to a software-controlled interaction layer, including graphical, textual, or auditory components, through which a user provides information input and perceives output such as response candidates, proposal information, and operation options.

The term “information input” refers to data provided by a user through the user interface, including natural language text, voice-derived text, selection signals, or other interaction data that expresses a request, preference, or intent.

The term “user identification information” refers to data that associates information input and usage history with a specific user, such as a user identifier, account identifier, or other correlation data enabling user-specific processing.

The term “usage history information” refers to data describing past interactions of a user with the system or external services, including past queries, selected items, completed reservations, purchases, reproductions, and associated timestamps or context.

The term “intent information” refers to data representing a computationally inferred purpose or objective of the information input, such as a request for recommendation, a request for reservation, a request for purchase, or a request for information.

The term “keyword information” refers to one or more terms, phrases, or tokens extracted from the information input that characterize topics, constraints, or attributes relevant to subsequent processing.

The term “user preference information” refers to inferred data describing tendencies or likes of a user, such as favored categories, typical price ranges, preferred times, or favored locations, derived from usage history information or other behavioral data.

The term “emotion information” refers to data indicating an emotional state of a user, such as joy, sadness, fatigue, calmness, or excitement, derived by analyzing the information input or associated context.

The term “emotion analysis function” refers to a computational routine or model, implemented locally or remotely, that analyzes textual or other input signals to determine emotion information.

The term “external emotion analysis service” refers to a remotely accessible computing service that receives user-related data and returns emotion information computed by the service.

The term “prompt sentence” refers to a sequence of machine-readable natural language instructions or structured text that is constructed by the processor and supplied to a generative AI model to direct the generation of a response candidate.

The term “instruction content” refers to constraints and directives encoded in the prompt sentence, including specifications such as required output format, number of items, tone, language, or other generation parameters.

The term “output format” refers to a structured pattern of the generated response, such as a list, paragraph, bullet points, or key-value representation, that is specified in the prompt sentence.

The term “output number of items” refers to a specified count or range of recommended or described items that a response candidate is requested to contain.

The term “output tone” refers to a style or manner of expression for a response candidate, such as formal, casual, concise, or friendly, that is specified in the prompt sentence.

The term “generative AI model” refers to a machine learning model configured to generate natural language text or similar content in response to input data, including prompt sentences, by performing probabilistic or learned sequence generation.

The term “response candidate” refers to text or structured content generated by the generative AI model in response to a prompt sentence, prior to any post-processing that resolves references to concrete items.

The term “external information providing device” refers to a remote or separate computing system or service that supplies candidate information sets such as catalog data, availability information, pricing data, or content descriptions.

The term “candidate information set” refers to a collection of data records describing potential items, such as content items, services, or products, that are eligible for recommendation, reservation, purchase, or reproduction.

The term “referred target item” refers to an item described, directly or indirectly, within the response candidate and corresponding to at least one item in the candidate information set.

The term “structured proposal information” refers to data produced by the processor that links each referred target item to machine-usable attributes such as identifiers, prices, times, and locations, in a format enabling direct execution of backend processes.

The term “identifier information” refers to data that uniquely or specifically identifies an item within a system or across systems, such as an item identifier, content identifier, reservation identifier, or product identifier.

The term “price information” refers to data indicating a monetary amount or cost associated with an item, including one or more currency values or pricing conditions.

The term “time information” refers to temporal data associated with an item or process, including dates, times of day, time ranges, or schedules relevant to availability, reservation, or reproduction.

The term “location information” refers to spatial data associated with an item or process, including addresses, geographic coordinates, or region identifiers indicating where a service or content is provided.

The term “operation option” refers to a selectable control or command presented through the user interface, associated with a target item, and indicating a specific procedure such as reservation, purchase, or reproduction.

The term “reservation process” refers to a computerized sequence of operations that establishes a future right or booking for a service or resource, such as a seat, table, or time slot, through communication with internal or external systems.

The term “purchase process” refers to a computerized sequence of operations that completes an acquisition of goods or services, including payment authorization, charge processing, and confirmation of the transaction.

The term “reproduction process” refers to a computerized sequence of operations that initiates rendering or playback of digital content, such as audio, video, or other media, in response to a user selection.

The term “external settlement device” refers to a remote or separate computing system or service that processes financial transactions, including payment authorization, charging, and settlement.

The term “external reservation device” refers to a remote or separate computing system or service that manages reservation records, availability data, and confirmation of bookings.

The term “selection operation” refers to an action performed by a user through the user interface, such as a click, tap, or other input event, that indicates chosen operation options or items.

The term “updated usage history information” refers to usage history information that has been augmented or modified to include results of executed processes, such as completed reservations, purchases, or reproductions.

The term “prompt generation rule” refers to logic, parameters, or templates stored in the storage device that define how the processor constructs prompt sentences from inputs including intent information, keyword information, user preference information, and emotion information.

The term “preference estimation model” refers to an algorithmic model, implemented by software and executed by the processor, that infers or updates user preference information based on usage history information, selection results, or other behavioral data.

The term “past prompt sentences” refers to previously generated prompt sentences that have been used to condition the generative AI model and are stored for later analysis or adaptation.

The term “past response candidates” refers to response candidates generated by the generative AI model in response to past prompt sentences and stored for use in improving future processing.

The term “past selection results” refers to data indicating which operation options or target items were selected or not selected by the user in response to prior structured proposal information.

The term “dynamically adjust future content of the prompt sentence” refers to modifying, in real time or over time, the structure, parameters, or content of subsequently generated prompt sentences based on stored rules, models, and observed user outcomes.

In one embodiment, a server, a terminal, and a network cooperate to implement the claimed system. The server includes at least one processor, a main memory, a non-volatile storage device, and a network interface. The processor is, for example, a multi-core central processing unit and optionally a graphics processing unit. The non-volatile storage device is, for example, a magnetic disk drive array or a solid-state storage array. The network interface supports packet-based communication such as TCP/IP over a wired or wireless network.

The server executes an operating system such as a general-purpose server operating system, and one or more application programs. The application programs include a web application layer implemented, for example, by a web server framework, an application programming interface (API) layer, a natural language processing module, a preference estimation module, an emotion analysis client module, a prompt generation module, a generative AI client module, a response resolution module, a transaction orchestration module, and a model update module. The server stores in the storage device a user database, a history database, a prompt-and-response log database, a configuration database, and trained model parameters for preference estimation and prompt generation.

The terminal is, for example, a handheld communication terminal or a personal computing device, equipped with a processor, a display, an input unit such as a touch-sensitive panel or keyboard, a microphone, a speaker, a memory, and a wireless or wired communication interface. The terminal executes an operating system such as a mobile operating system or a desktop operating system and an application program that presents a user interface, collects user input, and exchanges data with the server using a secure protocol such as HTTPS.

The user operates the terminal to input information in natural language, such as text entered via a soft keyboard or speech captured by the microphone and converted into text by a local speech recognition function. The terminal displays a text input area and visible controls and sends the resulting information input, together with user identification data, device type, time data, and optional location data, to the server.

The server stores each received information input and associated metadata in the storage device using a structured data schema. In one example, the server stores an information input record in a user history table with fields including user_id, input_text, timestamp, device_type, location, and context_flags. The server thereby maintains a structured usage history suitable for high-speed indexed retrieval.

The server implements the natural language processing module using a general-purpose programming language and a language processing library such as a tokenization and part-of-speech tagging library. The server uses this module to transform the raw input_text into a sequence of tokens, to assign part-of-speech labels, and to detect named entities and salient phrases. The server further applies an intent classifier implemented, for example, as a neural network model that takes as input a fixed-length feature vector derived from the tokens. The server constructs this feature vector by concatenating, for example, word embedding vectors, part-of-speech tag embeddings, and simple numeric features such as message length or presence of special words.

In one implementation, the intent classifier is a feed-forward neural network having an input layer, one or more hidden layers with non-linear activation functions such as rectified linear units, and an output layer that produces probability scores over a predefined set of intent classes such as recommendation, reservation, purchase, playback, and general question. The server stores the trained weights of this network in the storage device and loads them into memory at startup. The server selects as the intent information the intent class having the highest probability.

The server implements the preference estimation module using a machine learning model that maps usage history features to user preference information. The server constructs a fixed-length feature vector for each user by aggregating and encoding history records, for example by computing genre frequency distributions, average price points, typical time-of-day distributions, and location clusters. The server stores these feature vectors in a user profile table. The server uses a supervised learning algorithm such as logistic regression, gradient-boosted trees, or a deep neural network to estimate one or more preference scores, such as a probability that the user prefers a certain category or a continuous numeric preference intensity. The server thereby obtains user preference information that can be reused across sessions.

The server uses the emotion analysis client module to obtain emotion information. In one embodiment, the server sends the text of the information input to an external emotion analysis service using an application programming interface. The external service returns a structured result including, for example, multiple emotion scores. The server interprets these scores by applying thresholding and selection rules to assign a discrete label such as joy, sadness, anger, or fatigue. The server stores the emotion label and raw scores in an emotion history table, keyed by user_id and timestamp.

The server uses the prompt generation module to construct a prompt sentence based on the intent information, keyword information, user preference information, and emotion information. The server stores, in the configuration database, a set of prompt templates for different intent classes. Each template defines a text pattern with placeholders for context variables and explicit instruction content specifying an output format, an output number of items, and an output tone.

The server fills a selected template with values derived from the current input and history. In one example, for a movie recommendation request, the server generates a prompt sentence of the following form:

“User message: ‘I want to watch a fun movie this weekend.’ Past history: prefers action movies and superhero films. Current emotion: joy. Candidate movies: [Title A-action, Title B-action, Title C-science fiction]. From these candidates, choose the 3 best movies for this weekend and explain in one sentence why each is a good match. Answer in English.”

In another example, for a restaurant recommendation, the server generates:

“Based on the user's past dining history and the fact that the user likes Italian food, suggest the best Italian restaurant options nearby, including restaurant name, atmosphere description, and typical price. Optimize for a relaxed weekend dinner.”

In still another example, for music discovery, the server generates: “User message: ‘I want to listen to some new music.’ Past history: prefers upbeat pop and electronic. Current emotion: excited. Suggest 10 new songs in these genres that match the excited mood, and briefly describe why each song fits.”

The server provides the generated prompt sentence to the generative AI client module. The generative AI client module communicates with a generative AI model. In one embodiment, the generative AI model runs as a remote service accessible via an API; in another embodiment, the generative AI model runs locally on the server using a model serving framework.

The generative AI model is, for example, a transformer-based language model having multiple self-attention layers, positional encoding, and a large vocabulary. The server represents the prompt sentence as a sequence of token indices and provides them as input to the model. The model uses learned weight matrices and attention mechanisms to compute a sequence of hidden states and predicts the next token probabilities until a termination condition is met. The server controls generation parameters such as temperature, maximum length, and top-k or nucleus sampling thresholds to balance diversity and determinism. The server receives the resulting token sequence, converts it back into natural language text, and stores the resulting response candidate.

The server implements the response resolution module to map the textual response candidate to concrete items. The server first identifies candidate items relevant to the current intent by using external information providing devices. For example, for the movie intent, the server queries an external content catalog service or showtime service, passing criteria such as location, time window, and preferred genres. The server receives structured records including identifiers, titles, genres, runtime, prices, showtimes, and locations, and stores them in a candidate information set data structure, for example a table in memory keyed by item identifiers and with additional indices on titles and categories.

The server then analyzes the response candidate by applying string matching and optional fuzzy matching algorithms to identify referred target items. The server compares textual mentions in the response candidate with item titles or aliases in the candidate information set. Once the server establishes a correspondence between the referred target items and the entries in the candidate information set, the server constructs structured proposal information by selecting, for each referred target item, relevant fields such as identifier information, price information, time information, and location information. The server serializes the structured proposal information into a format suitable for transmission to the terminal and for driving backend processes.

The server thereby transforms unstructured natural language output of the generative AI model into structured, machine-usable representations tied to concrete items and external systems. This structured representation allows the server to generate a user interface presentation that supports single-operation execution of reservation, purchase, or reproduction functions, reducing round-trip communications and repeated context resolution.

The terminal receives the structured proposal information and the associated descriptive portions of the response candidate from the server. The terminal displays the descriptive text as human-readable explanations and renders interactive elements such as buttons or selection controls associated with each target item. The terminal links each displayed control to a corresponding operation option, such as “Reserve now”, “Buy now”, or “Play now”, and sends the selected operation options back to the server upon user interaction.

The server executes the transaction orchestration module when the user initiates an operation.

The server validates the requested operation, retrieves the associated structured proposal information, and calls appropriate external reservation devices or external settlement devices. For a reservation, the server transmits item identifiers, time information, and user details, and receives confirmation identifiers and final schedules. For a purchase, the server transmits item identifiers, price information, and payment tokens, and receives authorization and settlement results. For reproduction, the server sends content identifiers or streaming URLs to the terminal.

The server stores the outcome of each operation, including success or failure, in the history database. The server updates usage history information with fields such as selected_item_id, operation_type, success_flag, and timestamp. The server also appends an interaction log entry associating the prompt sentence, the response candidate, and the user's selection result. These data form the basis for updating the prompt generation rule and the preference estimation model.

The server implements the model update module to improve system performance over time. In one embodiment, the server periodically samples entries from the prompt-and-response log database and constructs training examples in which input features include attributes of the prompt sentence, response candidate content features, and user outcomes, and labels indicate whether particular types of responses or item orders led to successful user actions. The server uses a loss function, such as cross-entropy loss or mean squared error, to evaluate prediction quality and updates model parameters using gradient descent or a variant thereof such as Adam optimization. The server thereby refines preference scores or learns weights that influence prompt template selection and parameter settings.

The server also updates the prompt generation rule by adjusting template choices or parameter defaults based on observed success rates. For example, if a particular template yields a higher rate of completed reservations than others for a certain intent and preference combination, the server increases the probability of selecting that template for future similar cases. In this way, the server implements a non-conventional feedback loop that uses actual user behavior to modify how the processor constructs prompt sentences, rather than relying on static, manually coded prompts.

This architecture provides several technical effects. By integrating intent information, keyword information, user preference information, and emotion information into the prompt sentence, the server reduces the number of generative AI calls needed to obtain a response acceptable to the user. Because the generative AI model receives a richer and more constrained context, the model can emit more focused response candidates that closely match external candidate items. As a result, the server requires fewer parsing and reconciliation steps, thereby decreasing processor cycles and reducing memory usage.

By transforming response candidates into structured proposal information and linking them to external information providing devices, the server eliminates the need for repeated manual context reconciliation, lowers network traffic by avoiding unnecessary re-querying of external services, and enables the terminal to present operation options that drive backend processes directly. This design improves end-to-end latency and lowers the computational overhead associated with user interaction loops.

By continuously updating the preference estimation model and the prompt generation rule based on prompt-and-response logs and selection results, the server causes future prompt sentences to become more predictive of successful actions. This iterative adaptation is not equivalent to merely automating human decision-making, because the server adjusts internal data structures (profiles, weights, and rules) in a manner that would not be feasible for a human operator at the same scale and speed. The processor thereby improves its own internal data management and computation pathways over time, resulting in improved computational efficiency, reduced misalignment between AI output and available items, and lower rates of failed or abandoned operations.

In another embodiment, the server uses a multi-head attention-based neural network as the preference estimation model. The server feeds a sequence of recent user actions, each encoded as an embedding of item category, time slot, and operation type, into the model. The attention layers compute context-aware preference signals. The server trains this model with a sequence prediction objective, such as predicting the next item category or operation type, by minimizing a cross-entropy loss. The server updates model weights accordingly. This sequence-aware modeling allows the processor to capture temporal patterns without predefined human rules, thereby enhancing prediction accuracy beyond simple frequency counting.

In another embodiment, the server incorporates data augmentation when training the intent classifier and preference estimation model. The server generates synthetic examples by, for example, replacing item categories with similar categories or slightly altering time attributes within valid ranges. The server uses these augmented examples to improve model robustness. This approach improving model performance is not a mere business optimization but is a technical improvement in how the processor generalizes from finite training data to unseen inputs.

In still another embodiment, the server partitions data structures and processing pipelines across multiple processing nodes. The server maintains separate microservices for the natural language processing module, the generative AI client module, and the transaction orchestration module. The server routes user requests among these services using a service mesh or message queue system. The server uses caching strategies for user profiles and candidate information sets to reduce repeated disk access and to minimize remote API calls. These structural design choices contribute to lower latency, higher throughput, and better resource utilization.

In each of these embodiments, the server, the terminal, and the generative AI model cooperate to perform specific, non-generic computer operations on particular data structures, including structured history records, user profile vectors, prompt templates, token sequences, candidate information sets, and structured proposal records. The system thereby goes beyond a generic combination of data acquisition, analysis, and display, and instead defines an integrated technical solution that improves computer operation itself by reducing processing overhead, enhancing matching precision between AI outputs and concrete items, and enabling efficient, single-operation execution of reservation, purchase, and reproduction processes.

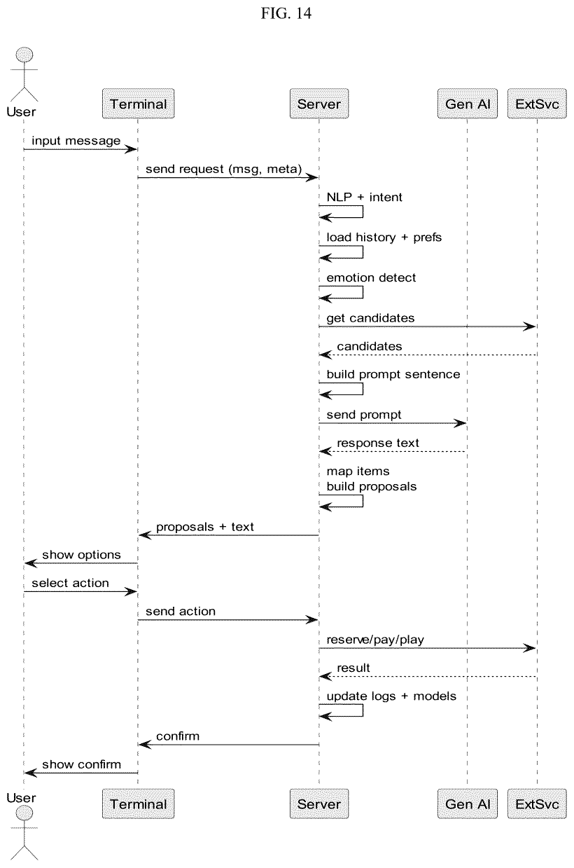

The following describes the processing flow using FIG. 14.
Step 1:

User operates the terminal and inputs information such as a natural language message (“I want to watch a fun movie this weekend”), using a keyboard, touch panel, or microphone.

Input: Raw user utterance (speech or text), user ID, and terminal context.

Output: Text string representing the user message and associated metadata packaged in a request object.

Terminal converts speech to text if necessary using a local speech-recognition function, attaches user identification data, timestamp, device type, and optional location information, and encapsulates these as a structured payload.
Step 2:

Terminal sends the structured payload to the server via a secure communication channel, such as HTTPS to a predefined API endpoint.

Input: Request object containing user message text and metadata.

Output: Network message delivered to the server's API layer.

Terminal serializes the payload into a network format, sets appropriate headers (for example, content-type and authentication tokens), and transmits the request through a network interface.
Step 3:

Server receives the network request and stores the raw message and metadata in a history table within a storage device.

Input: Network request containing user message text and metadata.

Output: Persistent record in a user history database row or document.

Server parses the HTTP request, validates authentication, and inserts a record with fields such as user_id, input_text, timestamp, device_type, and context_flags into a database using a data-access library.
Step 4:

Server performs natural language preprocessing on the user message to obtain token sequences, part-of-speech tags, and candidate keywords.

Input: Text string of the user message.

Output: Token list, part-of-speech tag list, and keyword list.

Server invokes a language processing library to segment the text into tokens, assign grammatical tags, and compute basic features such as term frequencies; the server then selects high-salience tokens as keyword information.
Step 5:

Server infers the intent information by feeding extracted linguistic features into an intent classification model.

Input: Token list, part-of-speech list, and derived numeric features.

Output: Intent label and intent confidence scores.

Server constructs a feature vector (for example, concatenation of word embeddings and length features), passes it through a trained neural network or classifier, computes class scores via matrix multiplications and activation functions, and selects the intent label with the maximum score.
Step 6:

Server retrieves past usage history records associated with the user ID from the storage device and constructs an aggregated user profile vector.

Input: User ID and history table contents for that user.

Output: Aggregated feature vector representing user preference signals.

Server executes a database query to obtain past interactions, transforms each record into categorical and numeric encodings (genre counts, average spend, time-of-day histograms), and aggregates them (for example, by summation and normalization) into a compact feature vector.
Step 7:

Server estimates user preference information by applying a preference estimation model to the user profile vector.

Input: User profile feature vector.

Output: Preference scores for categories, price ranges, times, or other attributes.

Server loads the model weights, performs one or more matrix multiplications and non-linear transformations on the feature vector, and computes numeric scores indicating the likelihood that the user prefers particular categories or conditions.
Step 8:

Server obtains emotion information by sending the user message to an emotion analysis function or external service and interpreting the returned scores.

Input: User message text and optional contextual metadata.

Output: Emotion scores and a discrete emotion label.

Server transmits the text to the emotion analysis endpoint, receives probability or intensity scores for several emotion classes, applies thresholding or argmax selection to derive a label (for example, joy), and stores both raw scores and the label.
Step 9:

Server queries one or more external information providing devices to collect a candidate information set relevant to the inferred intent and preferences.

Input: Intent label, user preference scores, and optional location and time context.

Output: Candidate information set containing structured records for items (for example, movies, restaurants, songs, or products).

Server constructs API query parameters (category filters, location bounds, time windows), sends them to external catalog or schedule services, parses the returned JSON or structured data, and caches the resulting records in memory.
Step 10:

Server filters and ranks the candidate information set according to user preference information and emotion information to produce prioritized item candidates.

Input: Raw candidate information set, preference scores, and emotion label.

Output: Ranked candidate list with attached relevance scores.

Server computes a relevance score for each item using a scoring function that combines preference alignment, distance or availability, and emotion-compatible attributes, then sorts the items by score and trims the list to a manageable size.
Step 11:

Server selects an appropriate prompt template based on the intent information and constructs a context-rich prompt sentence using extracted and inferred data.

Input: Intent label, keyword list, user preference scores, emotion label, and ranked candidate list.

Output: Prompt sentence for the generative AI model.

Server retrieves a template from configuration storage, substitutes placeholders with actual values (for example, inserting user message text, summarized preferences, emotion label, and a compact description of top candidate items), and concatenates instructions specifying output format, number of items, and tone.
Step 12:

Server logs the constructed prompt sentence alongside a reference to the current interaction for future analysis.

Input: Prompt sentence and interaction identifiers.

Output: Persistent log entry in a prompt-and-response database.

Server writes the prompt text, timestamp, user ID, intent label, and candidate snapshot ID into a log table, enabling subsequent offline model evaluation and tuning.
Step 13:

Server sends the prompt sentence to a generative AI model and controls generation parameters to obtain a response candidate.

Input: Prompt sentence text and generation parameters (for example, temperature, max tokens).

Output: Generated response candidate in natural language.

Server tokenizes the prompt, sends token indices and parameter values to the generative AI inference endpoint, waits for token-by-token generation, and reconstructs the textual response from the output token sequence.
Step 14:

Server analyzes the response candidate to identify textual mentions of items and maps them to elements in the candidate information set.

Input: Response candidate text and candidate information set.

Output: Set of referred target items with links to corresponding structured records.

Server extracts potential item names or descriptions from the response using pattern matching or named-entity recognition, applies exact and fuzzy string matching against item titles or aliases in the candidate information set, and resolves each mention to a unique item identifier where possible.
Step 15:

Server constructs structured proposal information by associating each resolved target item with machine-usable attributes.

Input: Referred target item identifiers and corresponding candidate records.

Output: Structured proposal objects including identifier, price, time, location, and explanatory text.

Server copies relevant fields (for example, id, display_name, price, showtime, address) from the candidate records, attaches the explanatory sentence or summary excerpted from the response candidate, and arranges them into a structured format suitable for rendering and execution.
Step 16:

Server sends the structured proposal information and associated descriptive portions of the response candidate back to the terminal.

Input: Structured proposal objects and explanatory text.

Output: Response payload delivered to the terminal via a network message.

Server serializes the proposal information into a response body, sets appropriate headers, and transmits the payload over the network interface to the terminal.
Step 17:

Terminal receives the response payload and updates the user interface to present the proposed items and operation options.

Input: Response payload containing structured proposal information and explanatory text.

Output: Updated visual or auditory display with item cards and controls.

Terminal parses the payload, constructs UI components for each item (showing name, explanation, price, time, location), and attaches interactive elements such as buttons labeled “Reserve,” “Buy,” or “Play” linked to internal event handlers.
Step 18:

User reviews the displayed proposals and selects an operation option associated with a target item.

Input: Visual display of proposal items and controls.

Output: User selection event representing the chosen item and operation.

User taps or clicks on a button for a specific item, optionally providing additional input such as quantity or time slot through dialog controls on the terminal interface.
Step 19:

Terminal captures the user's selection event and constructs an action request to be sent to the server.

Input: User selection event, selected item identifier, and any additional user parameters.

Output: Structured action request payload for reservation, purchase, or reproduction.

Terminal reads the associated item ID and operation type from the UI state, gathers payment tokens or additional options if needed, and encapsulates them into a request object.
Step 20:

Terminal sends the action request to the server via a secure API call.

Input: Action request payload.

Output: Network message requesting execution of a specific operation.

Terminal serializes the request, sets authentication data, and transmits it through the network interface, while possibly showing a loading indicator during the transmission.
Step 21:

Server receives the action request and validates the operation parameters against internal state and candidate information.

Input: Action request payload and stored structured proposal information.

Output: Validated operation specification or an error condition.

Server checks that the item ID exists in the stored proposal set, verifies that the requested time slot and quantity are still available, and validates user authorization and payment data, producing a confirmed specification for the downstream process.
Step 22:

Server communicates with an external reservation device or external settlement device to execute the requested reservation or purchase.

Input: Validated operation specification (item ID, user details, price, time) and payment token if applicable.

Output: Transaction result including success or failure status and confirmation identifiers.

Server formats the operation specification into the external API's required format, sends it via a network call, receives a response containing confirmation codes or error messages, and interprets the response to determine operation success.
Step 23:

Server updates usage history information to record the executed operation and its outcome.

Input: Transaction result and associated operation specification.

Output: New or updated entries in the history database reflecting completed or failed operations.

Server inserts or updates records that include user_id, item_id, operation_type, success_flag, timestamp, and confirmation_id, thereby enriching the user's history for future analysis.
Step 24:

Server logs the association between the original prompt sentence, the response candidate, and the user's selection result in a prompt-and-response log.

Input: Prompt sentence text, response candidate text, and transaction outcome.

Output: Log entry linking generation context and user behavior.

Server creates a record that stores the prompt, response, derived intent, selected item, and whether an operation was completed, supporting later training and evaluation of models.
Step 25:

Server sends a confirmation or error response back to the terminal, summarizing the operation outcome.

Input: Transaction result data and confirmation identifiers.

Output: Confirmation payload including status and detail fields.

Server constructs a concise summary (for example, reservation code, date and time, total amount) or error explanation and transmits it to the terminal.
Step 26:

Terminal presents the confirmation or error information to the user in the user interface.

Input: Confirmation payload.

Output: Updated display showing success details or error messages.

Terminal formats the result into a readable view, optionally provides functions such as adding the event to a calendar, and allows the user to either close the confirmation or continue interacting.
Step 27:

Server periodically analyzes stored prompt-and-response logs and usage histories to update preference models and prompt generation rules.

Input: Historical prompt sentences, response candidates, and user selection results.

Output: Updated model parameters and prompt template configurations.

Server batches historical data into training sets, computes gradients of a chosen loss function with respect to model weights using backpropagation, applies an optimization algorithm to update weights, adjusts prompt template selection probabilities based on measured success rates, and writes the modified parameters and rules back to the storage device for use in future interactions.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

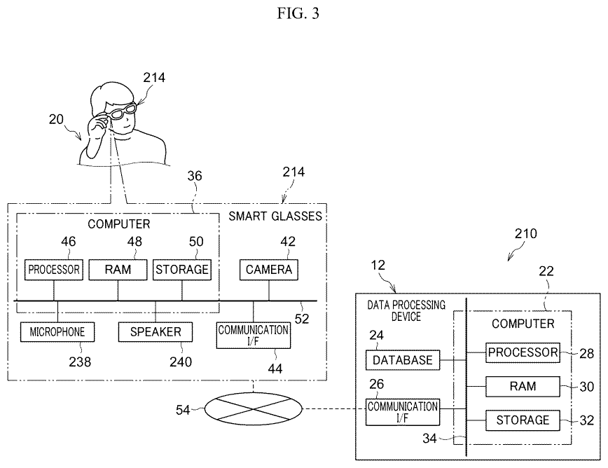

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

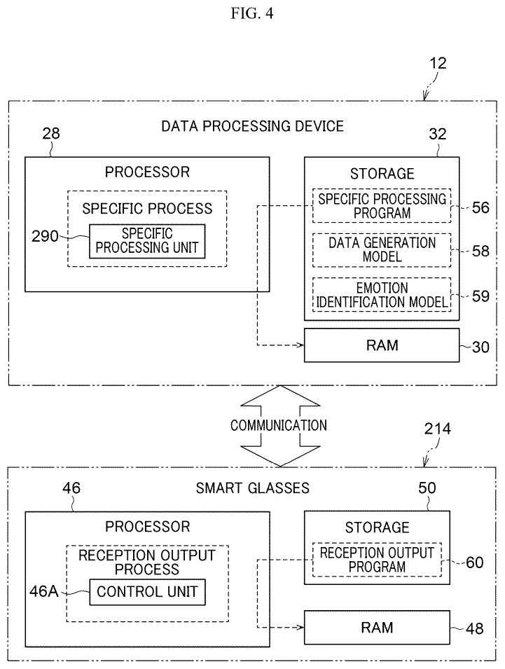

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

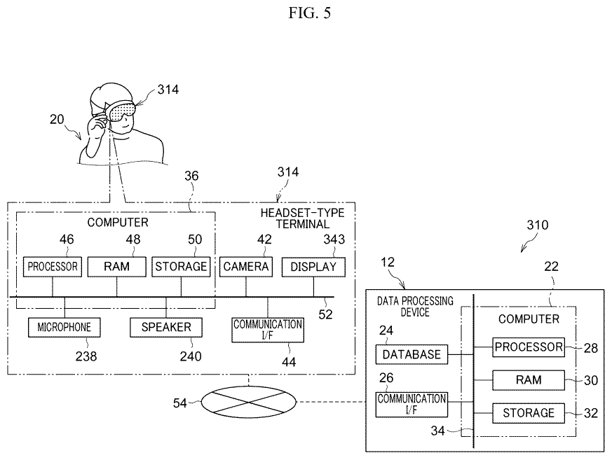

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

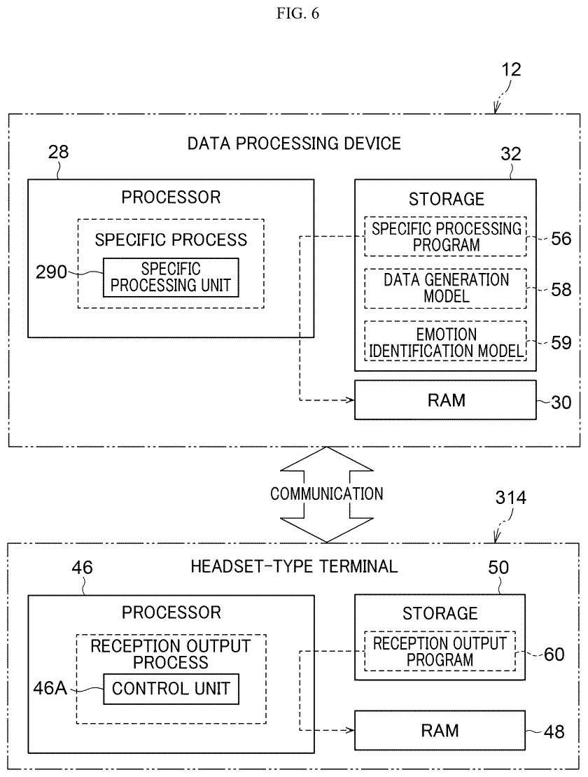

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

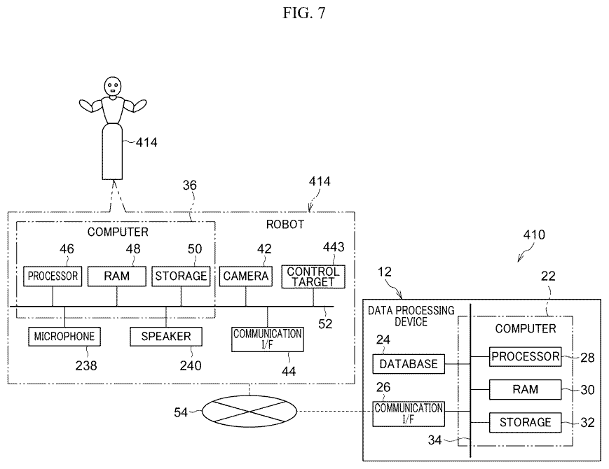

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

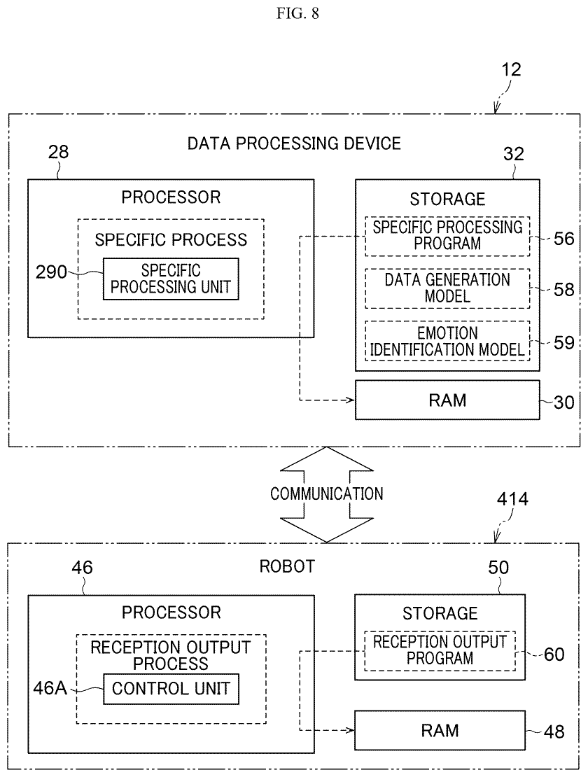

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

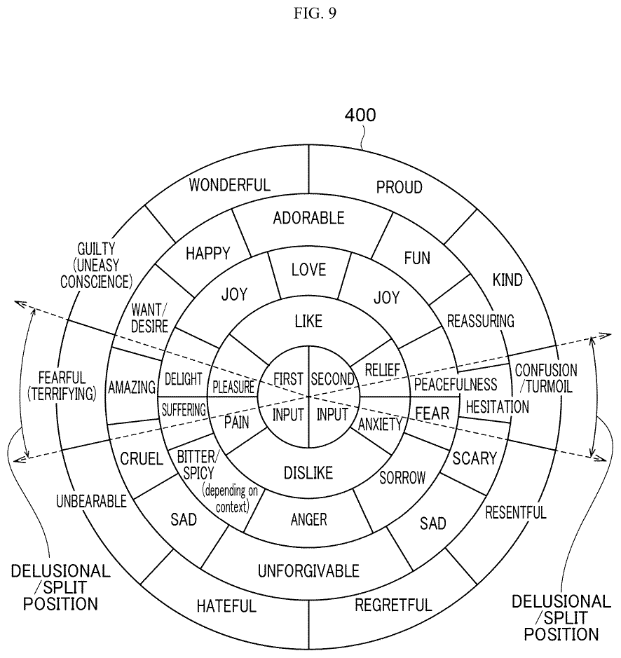

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

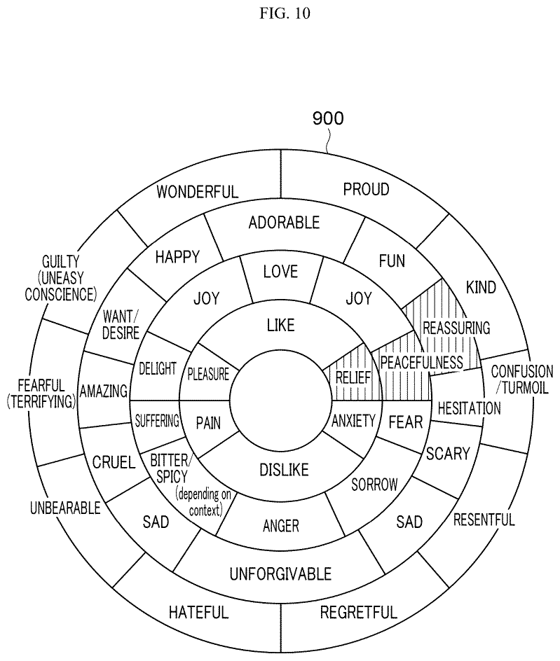

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive information input from a user via a terminal, convert the information input into structured data, and transmit the structured data via a communication network,
receive, via the communication network, the structured data transmitted from the terminal, and, on a basis of content and attributes included in the information input, dynamically generate a prompt sentence that instructs a generative AI model to generate a candidate response,
input the prompt sentence into the generative AI model, cause the generative AI model to perform natural language processing to generate the candidate response, and acquire the generated candidate response,
generate response data including display data for presentation to the user and option information indicating selectable processing options that are executable immediately by the user, on a basis of the candidate response, and
transmit the response data to the terminal via the communication network so that the candidate response and the processing options are presented through a user interface of the terminal.

### Supplementary 2

The system according to supplementary 1,
wherein the processor is configured to
in a case where the information input includes a specific identifier, extract the specific identifier from the information input, perform a search process on past information stored in a storage device on a basis of the specific identifier, and, on a basis of a search result, generate the prompt sentence including a condition and a constraint for proposing optimal data, and cause the generative AI model to extract related data from the past information.

### Supplementary 3

the system according to supplementary 1,

wherein the processor is configured to
generate the response data by generating operation information including procedure items selectable by the user on the user interface of the terminal, on a basis of the candidate response generated by the generative AI model and the related data extracted from the past information, and generate control information for executing predetermined transaction processing or registration processing on a basis of a selection of the procedure items received from the terminal.

### Application Example 1

### Supplementary 1

A system comprising a processor,
wherein the processor is configured to
acquire, from a terminal connected to an information processing apparatus, information input including a content of interest of a user,
convert the acquired information input into structured data and transmit the structured data to the information processing apparatus via a communication path,
obtain, in the information processing apparatus, past usage history information stored in a storage device on the basis of user identification information, and estimate a preference indicator of the user on the basis of the content of interest and the past usage history information,
generate a prompt sentence, on the basis of the content of interest and the preference indicator, for instructing a generative AI model, which is a generative information processing apparatus, to execute a generation process,
input the prompt sentence to the generative AI model, cause the generative AI model to generate a content candidate corresponding to the prompt sentence by natural language processing, and obtain a generation result of the content candidate in the information processing apparatus,
perform post-processing including at least one of conversion of the content candidate into a display format, adjustment of a length of the content candidate, and confirmation of safety of contents of the content candidate, and convert the post-processed content candidate into response data interpretable by the terminal,
transmit the response data to the terminal and cause the terminal to present the content candidate, in a user display area viewable or operable by the user,
receive, at the terminal, a user operation including at least one of a regeneration instruction with respect to the content candidate, a style change instruction with respect to the content candidate, and a new theme proposal request, and transmit an operation content of the user operation to the information processing apparatus, and
update, in the information processing apparatus, the prompt sentence in accordance with the operation content of the user operation and repeatedly execute an additional content generation process by the generative AI model using the updated prompt sentence.

### Supplementary 2

The system according to supplementary 1,
wherein the processor is configured to, when the information input or the user operation includes specific identification information or a request type, extract a plurality of candidate themes or candidate content types on the basis of the past usage history information and usage tendency information of other users, generate a prompt sentence for generating recommendation information describing the candidate themes or the candidate content types, cause the generative AI model to generate content including the recommendation information, and present a generation result as options to the user via a user interface of the terminal.

### Supplementary 3

The system according to supplementary 1,
wherein the processor is configured to, when presenting the content or the recommendation information, cause the terminal to present, to the user, an option group including at least one of a summary of the content, a structured item display of the content, and a list display of a plurality of candidates, and, in the information processing apparatus, update conditions of the prompt sentence automatically on the basis of a selection result by the user from the option group, and input the updated prompt sentence to the generative AI model to cause the generative AI model to generate procedure processing data or detailed content.

### Example 2

### Supplementary 1

A system comprising a processor,
wherein the processor is configured to receive information input from a user terminal and store the information input in a storage device,
detect a specific phrase included in the information input by performing language analysis on the information input,
upon detection of the specific phrase, acquire past information related to the user from the storage device and generate analysis data by integrating the past information,
generate a prompt sentence based on the analysis data and the information input so as to cause a generative AI model to infer a preference or a behavioral tendency of the user, and input the prompt sentence to the generative AI model to obtain estimation information regarding the preference or the behavioral tendency of the user,
acquire candidate information that is currently available from an external information providing apparatus,
select proposal information suitable for the user based on the candidate information and the estimation information, generate a prompt sentence for causing the generative AI model to generate a response content that presents the proposal information to the user terminal, and input the prompt sentence to the generative AI model to generate the response content, and transmit the response content and the proposal information to the user terminal.

### Supplementary 2

The system according to supplementary 1,
wherein the processor is configured to
structure preference information of the user based on the estimation information obtained from the generative AI model, update and store the structured preference information in the storage device, and, in generation of a subsequent prompt sentence, refer to the preference information and dynamically change content of the subsequent prompt sentence.

### Supplementary 3

the system according to supplementary 1,
wherein the processor is configured to
acquire transaction information or procedure information associated with the proposal information from an external processing apparatus, present, on a user interface of the user terminal, options based on the transaction information or the procedure information together with the response content, receive a selection from the user via the user terminal, and transmit a request for executing a reservation process or a purchase process to the external processing apparatus according to the selection.

### Application Example 2

### Supplementary 1

A system comprising a processor and a storage device,
wherein the processor is configured to
receive information input from a user via a user interface of a terminal device and store the information input in the storage device together with user identification information,
analyze the information input to extract intent information and keyword information, acquire past usage history information associated with the user identification information from the storage device, and estimate user preference information based on the past usage history information,
identify emotion information included in the information input by using an emotion analysis function or an external emotion analysis service, and store the emotion information in the storage device in association with the user identification information,
generate a prompt sentence including instruction content that specifies at least an output format, an output number of items, and an output tone, on the basis of the intent information, the keyword information, the user preference information, and the emotion information, and cause a generative AI model to generate a response candidate by inputting the prompt sentence into the generative AI model,
analyze the response candidate to identify a referred target item, compare the referred target item with a candidate information set acquired from an external information providing device, and generate structured proposal information in which the referred target item is associated with at least one of identifier information, price information, time information, and location information,
present the structured proposal information to the user via the user interface, and present, in association with each target item included in the structured proposal information, at least one operation option for executing a reservation process, a purchase process, or a reproduction process,
accept a selection operation performed by the user with respect to at least one of the operation options, execute at least one of the reservation process, the purchase process, and the reproduction process by communicating with at least one of an external settlement device and an external reservation device, and store a result of the executed process as updated usage history information in the storage device, and
update a prompt generation rule and a preference estimation model stored in the storage device on the basis of at least one of past prompt sentences, past response candidates, and past selection results by the user, and dynamically adjust future content of the prompt sentence generated for subsequent information input.

### Supplementary 2

The system according to supplementary 1,
wherein the processor is configured to, when the information input includes a specific identifier or a predetermined phrase, generate a prompt sentence including a description of conditions for selecting optimal data and a description of reasons for the selection on the basis of the usage history information and the emotion information, select the optimal data from a related candidate information set, and cause the generative AI model to generate the response candidate including a natural language explanation and a recommendation reason concerning the optimal data.

### Supplementary 3

The system according to supplementary 1,
wherein the processor is configured to control the user interface so as to display, based on the structured proposal information, a plurality of candidate items visually or audibly, associate, with each of the candidate items, at least one operation option for the reservation process, the purchase process, or the reproduction process, and present, together with each of the candidate items, an automatically generated explanatory text based on the response candidate, thereby enabling the user to execute the at least one process by a single operation.

What is claimed is:

1. A system comprising:
circuitry configured to:
receive, via a packet-switched network from a terminal device, input data provided by a user;
convert the input data into structured data by extracting content attributes and identifier attributes from the input data;
dynamically generate, based on the content attributes and the identifier attributes, a prompt instruction for a generative neural network model, the prompt instruction specifying conditions for generating a candidate response;
transmit the prompt instruction to the generative neural network model and acquire, from the generative neural network model, the candidate response generated by natural language processing;
detect, when the input data includes a specific identifier, the specific identifier from the input data, execute a search operation on stored records in a storage device based on the specific identifier, and generate a constrained prompt instruction that includes retrieval conditions derived from the search operation for causing the generative neural network model to extract related data from the stored records;
generate response data comprising display data derived from the candidate response and operation information defining selectable processing operations executable via a user interface of the terminal device; and
transmit the response data to the terminal device via the packet-switched network for rendering on a display of the terminal device.

2. The system according to claim 1, wherein the circuitry is configured to generate control information for executing a predetermined processing operation in response to selection information received from the terminal device indicating a user selection of one of the selectable processing operations.

3. The system according to claim 2, wherein the circuitry is configured to transmit the control information to an external processing apparatus via the packet-switched network to cause execution of the predetermined processing operation.

4. The system according to claim 3, wherein the predetermined processing operation comprises at least one of a reservation process, a registration process, or an acquisition process executed by communicating with the external processing apparatus.

5. The system according to claim 1, wherein the circuitry is configured to acquire past usage history information associated with user identification information from the storage device, estimate a preference indicator based on the input data and the past usage history information, and incorporate the preference indicator into the prompt instruction to cause the generative neural network model to generate the candidate response reflecting the preference indicator.

6. The system according to claim 5, wherein the circuitry is configured to structure the preference indicator as preference information, update and store the preference information in the storage device in association with the user identification information, and refer to the preference information when generating subsequent prompt instructions to dynamically adjust content of the subsequent prompt instructions.

7. The system according to claim 6, wherein the circuitry is configured to acquire image data and audio data from the terminal device, invoke an emotion analysis model to estimate an emotional state of the user based on the image data and the audio data, and use the estimated emotional state as an additional input feature for generating the prompt instruction.

8. The system according to claim 7, wherein the circuitry is configured to adjust an output tone, an output format, or an output item count specified in the prompt instruction based on the estimated emotional state.

9. The system according to claim 1, wherein the circuitry is configured to analyze the candidate response to identify a referred target item, compare the referred target item with a candidate information set acquired from an external information providing apparatus via the packet-switched network, and generate structured proposal information in which the referred target item is associated with at least identifier information, attribute information, and availability information.

10. The system according to claim 9, wherein the circuitry is configured to present the structured proposal information via the user interface and associate, with each target item, at least one operation option for executing a corresponding processing operation.

11. The system according to claim 10, wherein the structured proposal information comprises a plurality of candidate items presented visually on the terminal device, each candidate item associated with an automatically generated explanatory text derived from the candidate response.

12. The system according to claim 1, wherein the circuitry is configured to perform post-processing on the candidate response comprising at least one of conversion into a display format, adjustment of a length of the candidate response, and validation of content safety, and to convert the post-processed candidate response into the response data.

13. The system according to claim 12, wherein the circuitry is configured to receive, from the terminal device, a user operation comprising at least one of a regeneration instruction, a style change instruction, or a new theme request, and to update the prompt instruction in accordance with the user operation and re-execute the generative neural network model using the updated prompt instruction.

14. The system according to claim 1, wherein the circuitry is configured to, when the input data includes a specific identifier or a predetermined phrase, extract a plurality of candidate categories based on the past usage history information and usage tendency information of other users, generate a prompt instruction for generating recommendation information describing the candidate categories, and present the recommendation information as selectable options on the terminal device.

15. The system according to claim 14, wherein the circuitry is configured to update conditions of the prompt instruction based on a selection result by the user from the selectable options, and to input the updated prompt instruction to the generative neural network model to generate detailed content corresponding to the selection result.

16. The system according to claim 1, wherein the circuitry is configured to detect a specific phrase in the input data by performing language analysis, acquire past information related to the user from the storage device and generate analysis data by integrating the past information, and generate a prompt instruction based on the analysis data and the input data for causing the generative neural network model to infer a preference or a behavioral tendency of the user.

17. The system according to claim 16, wherein the circuitry is configured to acquire candidate information currently available from the external information providing apparatus, select proposal information suitable for the user based on the candidate information and estimation information output by the generative neural network model, and generate a prompt instruction for causing the generative neural network model to generate response content presenting the proposal information to the terminal device.

18. A system comprising:
circuitry configured to:
receive, via a packet-switched network from a terminal device, input data comprising content attributes and identifier attributes;
convert the input data into structured data conforming to a machine-processable format;
acquire past usage history information associated with user identification information from a storage device and estimate a preference indicator based on the input data and the past usage history information;
generate a prompt instruction based on the content attributes, the identifier attributes, and the preference indicator, the prompt instruction specifying conditions for a generative neural network model to generate a candidate response;
transmit the prompt instruction to the generative neural network model and acquire the candidate response;
detect a specific identifier in the input data, execute a search operation on stored records based on the specific identifier, and generate a constrained prompt instruction incorporating retrieval conditions for causing the generative neural network model to extract related data;
generate response data comprising display data and operation information defining selectable processing operations; and
transmit the response data to the terminal device via the packet-switched network and, upon receiving selection information from the terminal device, generate control information for executing a predetermined processing operation corresponding to the selection information.

19. The system according to claim 18, wherein the circuitry is configured to acquire image data and audio data from the terminal device, invoke an emotion analysis model to estimate an emotional state of the user, and incorporate the estimated emotional state into the prompt instruction to adjust at least one of an output tone, an output format, and content of the candidate response.

20. A method comprising:
receiving, via a packet-switched network from a terminal device, input data provided by a user;
converting the input data into structured data by extracting content attributes and identifier attributes from the input data;
dynamically generating, based on the content attributes and the identifier attributes, a prompt instruction for a generative neural network model, the prompt instruction specifying conditions for generating a candidate response;
transmitting the prompt instruction to the generative neural network model and acquiring, from the generative neural network model, the candidate response generated by natural language processing;
detecting, when the input data includes a specific identifier, the specific identifier from the input data, executing a search operation on stored records in a storage device based on the specific identifier, and generating a constrained prompt instruction that includes retrieval conditions derived from the search operation;
generating response data comprising display data derived from the candidate response and operation information defining selectable processing operations executable via a user interface of the terminal device; and
transmitting the response data to the terminal device via the packet-switched network for rendering on a display of the terminal device.
